(19) United States
(12) Patent Application Publication
(10) Pub. No.: US 2009/0113427 A1
(43) Pub. Date: Apr. 30, 2009

(54) Program Management Effectiveness

(76) Inventors: Glenn Brady, St. Louis, MO (US); Nicholas Sanders, Irvine, CA (US); Robert L. Carman, JR., Thousand Oaks, CA (US); Scott Elliot, San Francisco, CA (US); Ben Balzer, Thousand Oaks, CA (US); William K. Klimack, The Woodlands, TX (US)

Correspondence Address: FISH & RICHARDSON P.C., P.O. BOX 1022, MINNEAPOLIS, MN, 55440-1022, US

(21) Appl. No.: 11/923,826

(22) Filed: Oct. 25, 2007

(51) Int. Cl. G06F 9/46

(52) U.S. Cl. 718/100

(57) ABSTRACT

The present invention provides for a system and method for consistently evaluating program management effectiveness against established or historical benchmarks, involving defining specific performance areas by subfactors, weighting the subfactors, scoring the subfactors, and totaling all weighted subfactor scores to obtain a performance area score. By evaluating all performance area scores, a composite score for an evaluated program may be obtained. Scores may be compared to historical values and optimized based on such values.

### TECHNICAL FIELD

The present invention generally relates to systems and methods for evaluating program management effectiveness.

### BACKGROUND

Within the aviation, aerospace and defense contracting communities, program management has seen a heightened level of accountability and an increasingly competitive environment. Aviation, aerospace and defense programs such as new construction, major overhaul and conversion, and life-cycle management are often performed on critical infrastructure having direct effect on customer operations. Moreover, because of the typically high costs, and multi-year nature of aviation and defense programs, program managers must continually report progress and be accountable for cost overruns and timely delivery of products and services to the contract or program sponsor. Additionally, there is an increasingly competitive environment among aviation, aerospace and defense contractors. Companies wishing to successfully compete and maintain large enterprise level contracts must evaluate performance between programs and demonstrate a level of expertise or competence across many core competencies.

Previous management evaluation techniques have either focused on project management effectiveness or organizational management and leadership but have not addressed program management specifically. Project management evaluation tools generally focus on the effective completion of a one-time project or single deliverable with in resource constraints. Additionally, several quality management initiatives have attempted to address management effectiveness within an organization or across an enterprise. For example, the National Institute for Standards and Technology sponsors the Baldrige National Quality Program wherein companies use self-evaluation tools to assess the overall effectiveness of an organization's management as compared to certain quality-driven best practices.

But project management and quality management evaluation tools do not adequately evaluate the effectiveness of an organization's program management. Program management typically involves the management of multiple inter-related and inter-dependent projects to achieve an often recurring goal within resource constraints. Additionally, previous management evaluation tools do not provide a comparative framework to consistently evaluate program management effectiveness between different programs within an industry segment. Without consistency in evaluative techniques, it is difficult to compare program management effectiveness from one year to the next, to compare current programs with historical programs, or to compare program management effectiveness between divisions of the same organization. Accordingly, there is a need for a program management evaluation methodology that allows for consistent evaluation and critique of program effectives between different programs or within the same program between different performance periods.

The discussion of the background to the invention herein is included to explain the context of the invention. This is not to be taken as an admission that any of the material referred to was published, known, or part of the common general knowledge as at the priority date of any of the claims.

Throughout the description and claims of the specification the word “comprise” and variations thereof, such as “comprising” and “comprises”, is not intended to exclude other additives, components, integers or steps.

### SUMMARY

The present invention relates to systems and methods that address the need for a program management evaluation tool and methodology that allows for consistent evaluation and critique of program effectives between different programs or within the same program between different performance periods.

The present invention addresses the method of evaluating program management effectiveness within an industry segment comprising the steps of: defining one or more critical areas within an industry segment with one or more performance subfactors; scoring the one or more subfactors; weighting the one or more subfactors relative to all subfactors within the one or more critical areas; and scoring the one or more critical areas based on a weighted subfactor score.

### BRIEF DESCRIPTION OF TIRE DRAWINGS

FIG. 1 depicts a flow chart of an implementation of the present invention;

FIG. 2 depicts a system of an implementation of the present invention;

FIG. 3 depicts an exemplary interface for evaluating a critical performance area consistent with an implementation of the present invention;

FIG. 4 depicts an exemplary interface for evaluating and reporting critical performance area scores consistent with an implementation of the present invention;

FIG. 5 depicts an exemplary interface for evaluating a critical performance area consistent with an implementation of the present invention;

FIG. 6 depicts an exemplary interface for evaluating a critical performance area consistent with an implementation of the present invention;

FIG. 7 depicts an exemplary interface for evaluating a critical performance area consistent with an implementation of the present invention;

FIG. 8 depicts an exemplary interface for evaluating a critical performance area consistent with an implementation of the present invention;

FIG. 9 depicts an exemplary interface for evaluating a critical performance area consistent with an implementation of the present invention;

FIG. 10 depicts an exemplary interface for evaluating a critical performance area consistent with an implementation of the present invention;

FIG. 11 depicts an exemplary interface for evaluating a critical performance area consistent with an implementation of the present invention;

FIG. 12 depicts an exemplary interface for evaluating a critical performance area consistent with an implementation of the present invention;

FIG. 13 depicts an exemplary interface for evaluating a critical performance area consistent with an implementation of the present invention;

FIG. 14 depicts an exemplary interface for evaluating a critical performance area consistent with an implementation of the present invention;

FIG. 15 depicts an exemplary interface for evaluating a critical performance area consistent with an implementation of the present invention; and

FIG. 16 depicts an exemplary interface for evaluating a critical performance area consistent with an implementation of the present invention;

### DETAILED DESCRIPTION

The systems and methods of the present invention are directed to an evaluation method and system that addresses the need for consistent evaluation of program management effectiveness with comparison to established benchmarks, other programs, or the same program over different evaluation periods. The term “program” as used herein is meant to encompass an organizational plan of action to accomplish a specified end, characterized by a planned group of activities, procedures, and projects coordinated for a specific purpose.

Program management generally involves the management of large, multi-discipline, multi-year endeavors, often involving numerous prime contractor and sub-contractor relationships, though program management may also involve small discreet projects within both large and small organizations (e.g., Independent Research and Development efforts). Program management is the process of managing multiple ongoing inter-dependent projects. An example would be that of designing, manufacturing and providing support infrastructure for an automobile manufacturer. This requires hundreds, or even thousands, of separate projects, each one whose outcome may affect some or many of the others. In an organization or enterprise, program management also reflects the emphasis on coordinating and prioritizing resources across projects, departments, and entities to ensure that resource contention is managed from a global focus. Program management provides a layer above project management and is focused on selecting the best group of programs, defining them in terms of their constituent projects and providing an infrastructure where projects can be run successfully but leaving project management to the project management community.

Program management may generally be describe as the management level above project management and process management, and may incorporate both. Project management is the discipline of organizing and managing resources in such a way that such resources deliver all the work required to complete a project within defined scope, time, and cost constraints. A project is a temporary and often one-time endeavor undertaken to create a unique product or service, that brings about beneficial change or added value. Project management is concerned with the delivery of a project within the defined constraints. Additionally, project management attempts to optimize allocation and integration of the inputs needed to meet pre-defined objectives. The project, therefore, is a carefully selected set of activities chosen to use resources (money, people, materials, energy, space, provisions, communication, quality, risk, time, etc.) to meet the pre-defined objectives. Program management, however, is concerned with the management and coordination of multiple projects. Rather than focusing on one time endeavors, program management typically focuses on long term operations, having multiple, often repeat deliverables.

Program management responsibilities can vary. For instance, manufacturing program management responsibilities may be different than program management responsibilities for a pharmaceutical trial and data collection program. As such, industry segment and type likely determine the critical performance areas that best define successful program management. Additionally, the customer and other major stakeholders including government agencies may influence program management responsibilities and further determine program critical performance areas. A critical performance area is a program management function that is identified as essential to effective program management within a designated industry segment. For example, in the aerospace industry, an expertise in federal aviation regulations may be essential. An expertise in classified material management may be necessary for a defense related program. And an understanding of electronic component performance and reliability in a vacuum may be required for satellite design.

Critical performance areas may be further defined by subfactors that articulate specific levels of performance and exemplify effective program management practices within that performance area. For example, a key sub-factor for a classified materials management program would be an established system for maintaining program team member security clearances.

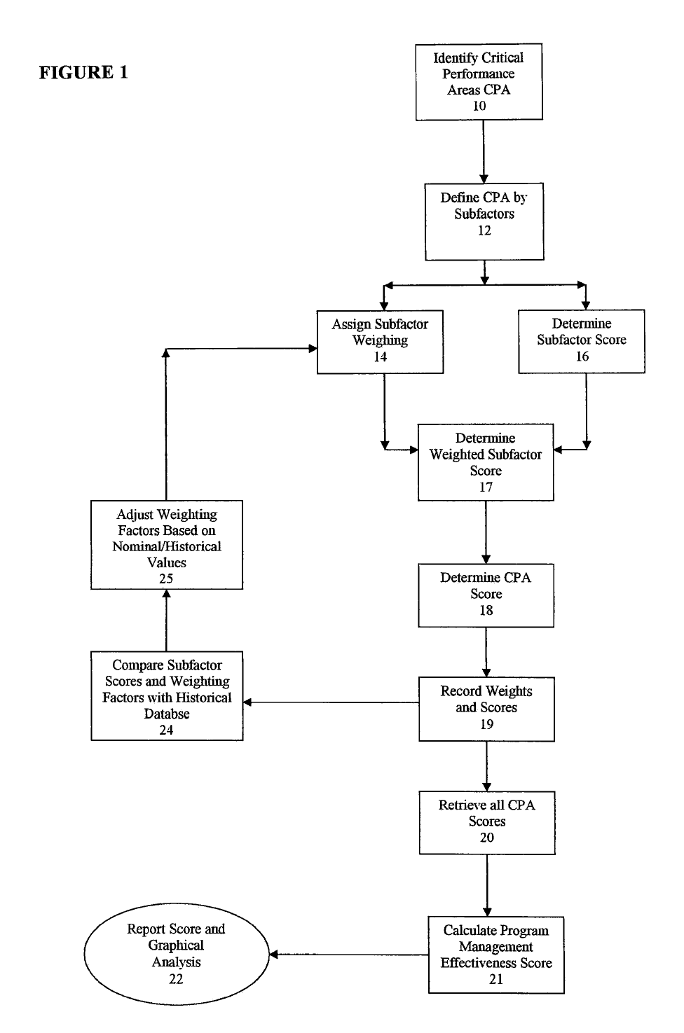

FIG. 1 illustrates a flow chart of an exemplary method for evaluating program management effectiveness. The methodology identifies critical performance areas for a particular industry segment, 10, and applies such critical performance areas to a program within that industry segment. Each critical performance area is further defined by one or more sub-factors, 12. The sub-factors may be assigned a weighting factor 14 and a score 16. In an implementation, the program and its management are evaluated within each sub-factor to determine a sub-factor score on a scale consistent between all sub-factors of each critical performance area. Each sub-factor score 16 is multiplied by the sub-factor weighting factor 14 to obtain a weighted subfactor score 17. The sum of all weighted sub-factor scores determines the score for a critical performance area, 18. The subfactor score, weighting factor, weighted subfactor score, and the critical performance area score are stored 19 for future processing and later historical evaluation. The method is repeated for each critical performance area identified in step 10 for a particular industry segment and all critical performance area scores retrieved 20. A program management effectiveness score is then calculated 21 from all the critical performance area scores and reported 22 with a raw score and a graphical report wherein each critical performance area score is compared graphically with all other critical performance area scores against a common axis that is consistent with the subfactor scoring scale. Critical performance areas, sub-factors, weighting factors, sub-factor scores, and critical performance area scores may be recorded in a database or other data structure for later comparison, or to adjust the weighting factors assigned to each subfactor based on historical values of weighting factors. In an implementation, subfactor scores and weighting factors may be compared 24 against a historical database and adjusted 25 based on historically optimized weighing factors, 24, where the optimized weighing factors are assigned to the weighing factor at step 14.

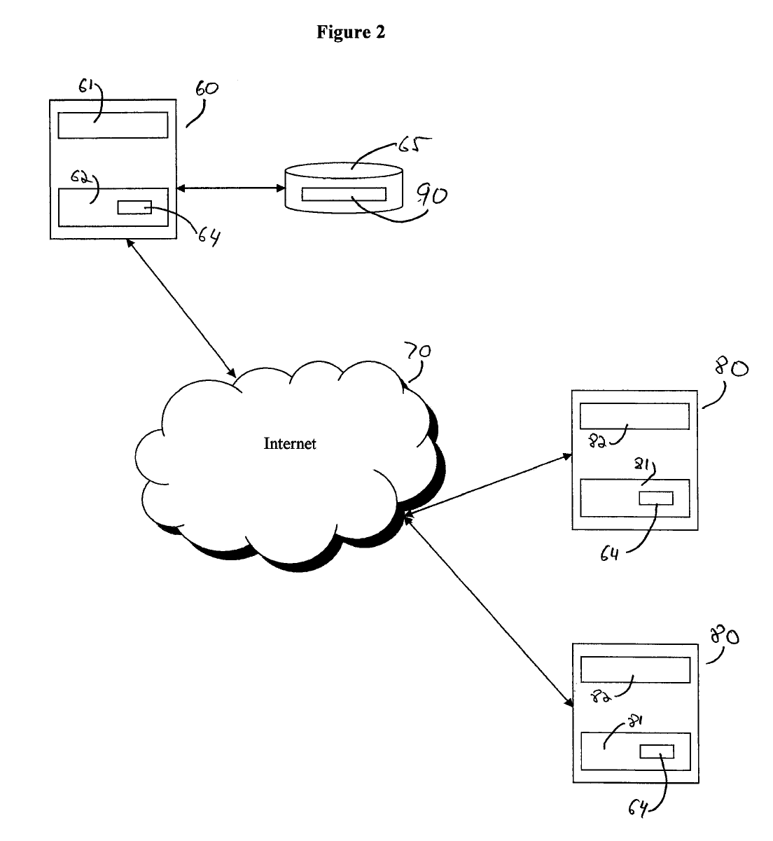

FIG. 2 depicts an implementation of a system incorporating the exemplary method depicted in FIG. 1. The system includes a server 60, a network 70, and multiple user terminals 80. Network 70 may be the Internet or any other computer network. User terminals 80 each include a computer readable medium 81, such as random access memory, coupled to a processor 82. User terminals 80 may also include a number of additional external or internal devices, such as, without limitation, a mouse, a CD-ROM, a display and a keyboard. Server 60 may include a processor 61 coupled to a computer readable memory 62. Server 60 may additionally include one or more secondary storage devices 65, such as a database.

Server processor 62 and user terminal processor 82 can be any of a number of well known computer processors, such as processors from Intel Corporation of Santa Clara, Calif. In general, user terminal 80 may be any type of computing platform connected to a network and that interacts with application programs, such as a personal computer, personal digital assistant, or a smart cellular telephone. Server 60, although depicted as a single computer system, may be implemented as a network of computer processors.

Memory 62 includes a program management effectiveness computer application 64, which determines the overall effectiveness of an organization's program management based on a user evaluation of pre-identified industry specific critical performance areas.

Program management effectiveness computer application 64 includes an industry catalog 90 or index of industry segments. For each industry segment, one or more critical performance areas define the best program management practices relevant to that industry segment. For each critical performance area, one or more sub-factors define the effectiveness and maturity continuum for the critical performance area. A grading or scoring scale is associated with each subfactor, in which the highest score on the scale represents a robust, effective, and mature subfactor. And the lowest score on the scale represents a non-existent or ineffective subfactor. Additionally, industry catalog 90 includes a weighting factor of between 0% and 100% for each subfactor. Industry catalog 90 may be integral to the program management effectiveness computer application 64 or may be its own application in communication with program management effectiveness computer application 64.

In the implementation depicted in FIG. 2, the user is prompted by program management evaluation computer application 64 to choose an industry segment. Alternatively, a user's access to industry segments may be restricted to one or more industry segments based on the user's profile, license, or subscription level. Program management effectiveness computer application 64 then populates a user interface with critical performance areas relevant to the selected industry segment chosen from industry catalog 90. Each critical performance area is further defied by subfactors and a grading continuum to evaluate the maturity of the subfactor as applied to a program of interest. The user assesses the program and enters a score from the grading continuum for each subfactor.

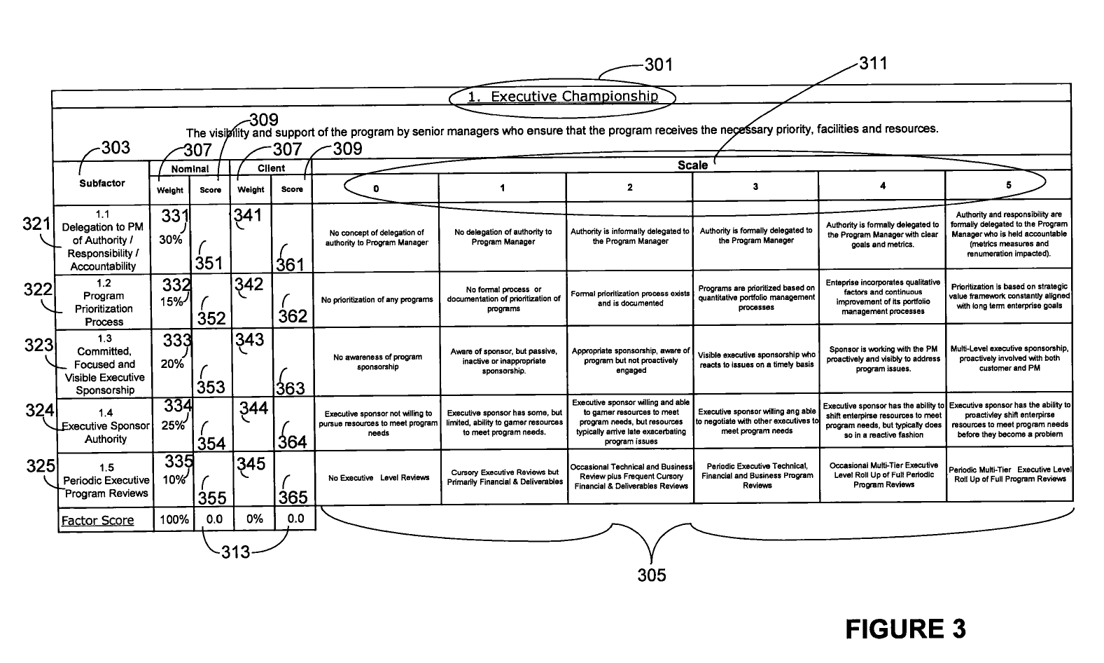

FIG. 3 depicts an exemplary interface for evaluating critical performance area 301 by its defining subfactors 303, scoring continuum 305, and weighting factors 307. The weighting factor 307 multiplied by a subfactor score 309 results in a weighted subfactor score 311, not shown. For example, subfactor N may have a weighting factor of 50%. Subfactor N may receive a score of 4. Therefore, the weighted subfactor score for subfactor N is equal to 2. By adding all weighted subfactor scores 311 for each subfactor 303, a critical performance area score 313 may be obtained.

Referring to the implementation of FIG. 2, program management effectiveness computer application 64 may also populate weighting factors for each subfactor. Weighting factors may be a predetermined nominal weighting factor, obtained from a historical analysis of previously applied weighting factors, or may be directly assigned by the user. It will be appreciated that any combination of pre-assigned, historically determined, or directly assigned weighting factors may be used as part of the systems and methods described herein. Additionally, weighting factors may be displayed to the user during the subfactor evaluation and scoring, may be hidden from the user, or may be revealed after the user has assessed the subfactor scores. The user may compare subfactor scores, weighting factors, and weighted subfactor scores with historical or nominal values stored in industry catalog 90. Program management effectiveness computer application 64 may suggest weighting factors based on such comparison and recalculate the weighted subfactor score based on the newly suggested nominal weighting factors.

Referring to FIG. 3, an exemplary interface includes critical performance area 301, here Executive Championship, further defined by multiple subfactors 321, 322, 323, 324, and 325. Subfactor 321 may be assigned a nominal weighting factor 331. Subfactor 322 may be assigned a nominal weighting factor 333. Subfactor 323 may be assigned a nominal weighting factor 333. Subfactor 324 is assigned a nominal weighting factor 334. And subfactor 325 is assigned a nominal weighting factor 335. Additionally, a unique or user specified weighting factor may be assigned to each subfactor by the user or client and recorded as client weighting factor 341, 342, 343, 344 and 345. It will be appreciated that the weighting factor for any particular subfactor may be between 0% and 100% and the sum of all weighting factors should equal 100%. Client weighting factors 341-345 may be the same or different than nominal weighting factors 331-335.

Scoring continuum 305 includes a subfactor scoring scale 311 which sets forth a common scale applied to all subfactors across all critical performance areas within the specified industry segment. Scoring continuum 305 sets forth a continuum of subfactor competence levels upon which the program and program management are evaluated. By evaluating program elements within each specified subfactor against the criteria set forth in the scoring continuum 305, a user or client determines a nominal subfactor score, 351, 352, 353, 354 and 355, as well as a client subfactor score 361, 362, 363, 364 and 365.

The exemplary interface of FIG. 3 may be implemented as a common spreadsheet, database, webpage or other means known in the art and is not limited to the specific embodiment shown.

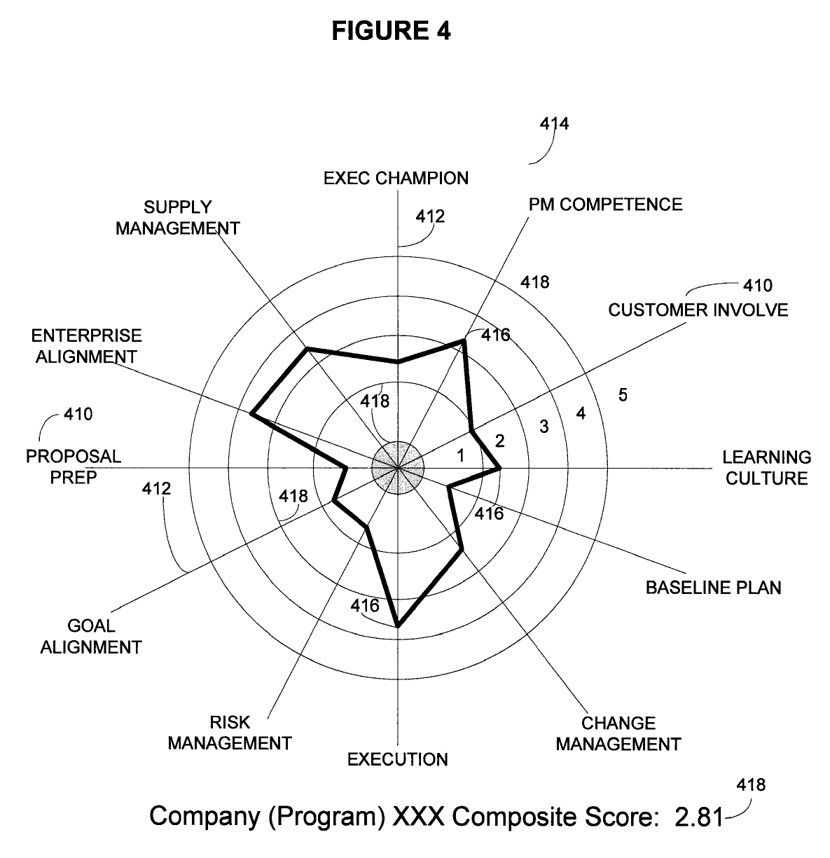

After calculating weighted subfactor scores for each subfactor within a critical performance area, a critical performance area score may be calculated by adding all weighted subfactor scores for that critical performance area. A program management effectiveness score can be determined by recording and reporting all critical performance area scores. FIG. 4 is an exemplary implementation of an interface for reporting the program management effectiveness score. Each critical performance area 410 represents an axis 412 on a spider diagram 414. A critical performance area score 416 is plotted on an axis 418 that is the same scale as the subfactor scoring scale 311 of FIG. 3. Other scales may also be used. In an implementation the program management effectiveness composite score 418 can be calculated by taking the average, weighted average, or area formed by connecting all points plotted on the spider diagram 414. Other statistical methods may be used to determine composite score 416. A program management effectiveness score can be obtained by determining the average or weighted average of all critical performance area scores for the designated industry segment.

Implementations of the present invention can be applied to any number of industry segments. By way of example and further clarification, a detailed discussion of critical performance areas, sub-factors, weighting factors, scores, and reporting methodology is provided below with regard to the aerospace, aviation and defense industries. It has been found that certain critical performance areas relating to management capabilities, organization, and program processes factor into a program's success and level of effectiveness within the aviation, aerospace and defense industries. More specifically, an aviation, aerospace or defense program's maturity in the following twelve categories has been found to be directly linked to program management effectiveness. The twelve categories, discussed in more detail below, generally comprise:

1) Executive Championship;

2) Program Management & Program Team Competence;

3) User/Customer Involvement & Expectations;

4) Learning Culture;

5) Program Baseline Planning & Resourcing;

6) Change Management;

7) Performance Measurement & Program Execution;

8) Risk Management;

9) Alignment of Goals & Objectives;

10) Proposal Preparation;

11) Process Alignment; and

12) Supply Base Leadership.

The above identified categories provide a consistent set of critical performance areas upon which all programs and program managers may be evaluated.

Due to the complexity and duration of programs within the aerospace, aviation and defense communities, evaluation of program management effectiveness against consistent categories allows for a comparison of program and program management performance from one program to another or within a single program between performance periods. Moreover, using consistent evaluation criteria facilitates the establishment of industry recognized benchmarks and service standards. Additionally, an archive of evaluation criteria allows for historical comparison and trend analysis over the legacy of a particular program or comparison of a current program with a past endeavor.

Each critical performance area, defining subfactors, nominal weighting factors, and scoring continuum elements for the aviation, aerospace and defense industry are discussed below.

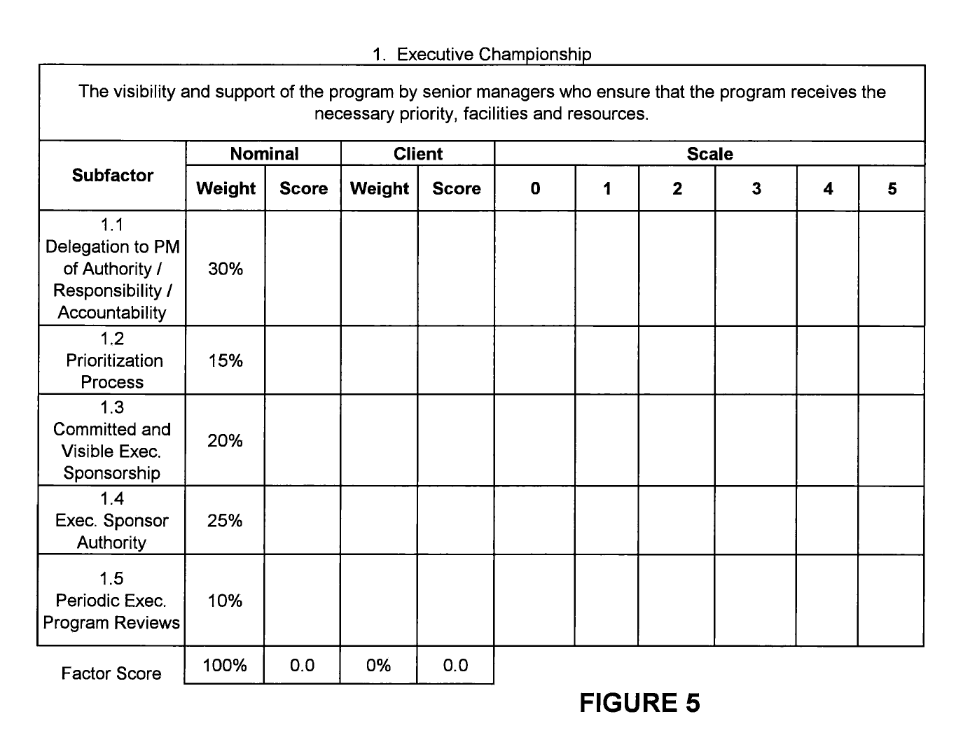

Executive Championship: FIG. 5 provides an example of an illustrative user interface for scoring and evaluating the executive championship critical performance area. In its broadest sense executive championship refers to the level of support a program receives from an organization's senior executives. Indeed, the visibility and support of the program by senior managers and executives ensures the program receives the necessary priority, facilities and resources. It has been found that executive championship is dependent on one or more subfactors, which may comprise: the level of delegation from an organization's senior executives to the program manager, including delegation of authority, responsibility, and accountability; the process by which senior executives within an organization prioritize between competing, simultaneous, or related programs; the degree to which an organizations executives outwardly and visibly sponsor a program, including continual, focused sponsorship; the level of authority, whether actual or perceived of executive sponsorship for a program; and the frequency and adequacy of periodic executive review of a program.

The maturity of a program's level of executive championship may be determined by comparing the program of interest against certain benchmarks. For example a six point subfactor scoring continuum and scoring scale may be tailored to the executive championship category. The maturity of executive delegation to the program manager may, for example, be give a score of zero to five depending on the level and quality of delegation. In the example provided in FIG. 5, a score of “0” or “1” may be awarded for no concept of delegation of authority from an organization's executives to the program manager. A score of 2 may be awarded if an organizations authority is informally delegated to the program manager. A score of “3” represents formal delegation from an organization's executive leadership to the program manager. A score of “4” represents formal delegation from an organization's executive leadership to a program manager with a clear articulation of goals and metrics. And a score of “5” represents formal delegation of authority and responsibility from an organization's executive leadership to the program manager who is held accountable for achieving articulated goals and metrics.

In a similar manner the effectiveness of an organization's ability to prioritize between programs may consistently be evaluated. Referring again to FIG. 5, a score of “0” may be awarded where no prioritization between programs occurs. A score of “1” may be awarded where no formal process or documentation of prioritization between programs exists or occurs. A score of “2” may be awarded where formal prioritization processes exist and documentation occurs. A score of “3” may be awarded where programs are evaluated and prioritized within an organization based on quantitative portfolio management processes. A score of “4” may be awarded wherein an organization incorporates qualitative factors and adopts continuous improvement of portfolio management processes across an enterprise level. And a score of “5” may be awarded wherein prioritization of programs is prioritized based on a strategic value framework which is continuously aligned with long term organizational or enterprise goals.

Also the level of executive sponsorship of a program may be consistently evaluated wherein a score of “0” is awarded if there is no awareness of program sponsorship at the executive level. A score of “1” may be awarded if an organization's executive management is aware of the program sponsor but sponsorship is ineffective, passive, inactive or inappropriate. A score of “2” may be awarded where executive sponsorship is appropriate and the executive is aware of the program but not proactively engaged. A score of “3” may be awarded when a program has visible executive sponsorship who reacts to issues in a timely manner. A score of “4” may be awarded when the executive sponsor works with the program manager proactively and visibly to address program issues. Finally, a score of “5” may be awarded when a program has multi-level executive sponsorship, proactively involved with both the customer and the program manager. For example, a program to integrate avionics systems with an new heads-up display in search and rescue aircraft should not ordinarily be sponsored at the executive level by an organizations general counsel.

The authority of the program's executive sponsor may be consistently evaluated against the following benchmarks. A score of “0” may be awarded when the executive sponsor is not willing to pursue resources to meet program needs. A score of “1” may be awarded when the program's executive sponsor has some, but limited ability to garner resources to meet program needs. A score of “2” represents a program executive sponsor who is willing and able to garner resources to meet program needs, but resources typically arrive late exacerbating program issues. A score of “3” may be awarded for a program having an executive sponsor willing and able to negotiate with other executives to meet program resource requirements and needs. A score of “4” identifies an executive sponsor who has the ability to shift enterprise resources to meet program needs, but typically does so in a reactive fashion. And a score of “5” represents a program executive sponsor who has the ability to proactively shift enterprise resources to meet program needs before they become a problem.

The extent of periodic executive program review is also indicative of a healthy level of executive championship within a program. In order to consistently evaluate between programs, the degree of executive review may be evaluated against the following benchmarks. A score of “0” represents a program that has no executive level review. A score of “1” may be awarded when a program undergoes cursory executive review that is primarily focused on financial information and deliverables. A score of “2” may be awarded for occasional technical and business review at that he executive level with frequent cursory review of financial information and deliverables. A score of “3” may be awarded for periodic executive level review of a program's technical requirements and achievements, financial information, and business programs. A score of “4” may be awarded for occasional multi-tier executive level roll up of full periodic program reviews. A score of “5” represents periodic multi-tier executive level roll up of full program reviews.

As is apparent from FIG. 5, the subfactors contributing the executive championship score of a program may each be evaluated against established bench marks. The subfactor scores may then be weighted according to program or organization specific criteria, or alternatively may be weighted against established or nominal weighted scores. The weight associated with each subfactor may be between 0 and 100%, though it has been found that nominal weighting factors for the executive championship subfactors with the following ranges are particularly useful for evaluating programs in the aviation and defense industries: Delegation to PM 1.1, weight of 20-40%; Program Prioritization Process 1.2, weight of 5-25%; Executive Sponsorship 1.3, weight of 10-30%; Executive Sponsor Authority 1.4, weight of 15-35%; and Periodic Executive Program Reviews, weight of 0-20%. The combined aggregate weight of subfactors 1.1 through 1.5 should total 100%. The Executive Championship category score may be calculated by multiplying the weight times the score for each subfactor and adding the results as indicated in the following formula:

Exec. Champ. Score=(W_{1.1}*S_{1.1})+(W_{1.2}*S_{1.2})+(W_{1.3}*S_{1.3})+(W_{1.4}*S_{1.4})+(W_{1.5}*S_{1.5})

In the implementation of FIG. 1, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or analysis industry categories.

Program Management & Program Team Competence:

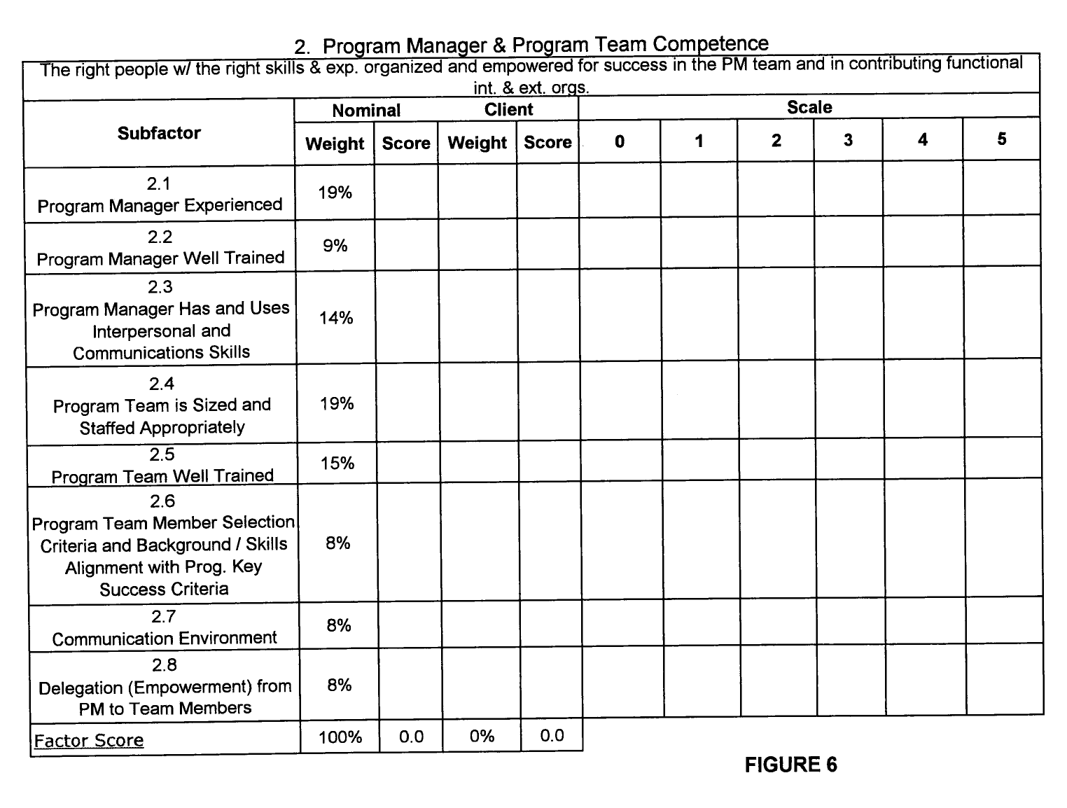

FIG. 6 provides an example of an illustrative score card relating to the Program Manager & Team Competence Category. In its broadest sense Program Manager & Team Competence refers the degree to which the right people with the right skills and experience are organized and empowered for success in the program management team and the extent functional internal and external organizations contribute to that program management team. For example, well developed and strong leadership having effective communications skills is required to integrate team members from multiple disciplines both in and out of the organization. This may include multiple contractors and sub-contractors. Additionally, competent engineering, cost accounting, and financial analysis skills may be required. As such, the competence of the program management team directly influences the effectiveness and performance of the program as a whole. It has been found that Program Management & Team Competence is dependent on one or more subfactors, which may comprise: Program Manager Experienced; Program Manager Well Trained; Program Manger Has and Uses Interpersonal and Communications Skills; Program Team is Sized and Staffed Appropriately; Program Team Well Trained; Program Team Member Selection Criteria and Background Skills Aligned with Program Key Success Criteria; Communication Environment; Delegation (empowerment) from Program Manager to Team Members.

The maturity of a program's level of manager and team competence may be determined by comparing the program of interest against certain benchmarks. For example, referring to FIG. 6, a subfactor scoring continuum may include the following elements.

Subfactor 2.1: Program Manager inexperience unrecognized. Program Manager inexperienced. Program Manager experienced in different type programs. Program Manager experienced/successful in similar programs & this program and respected in the Business Unit. Program Manager experienced/successful in similar & this program and respected in the corporate culture; Program Manager is recognized leader in program management field.

Subfactor 2.2: Program Manager Well Trained. Program Manager lacks of training unrecognized. Program Manager untrained. Program Manager trained in specialty skills. Program Manager trained/educated in program management skills. Program Manager trained/educated in specialty skills and program management skills. Program Manager trained/educated in specialty skills, program management skills, and in business skills; Program Manger is recognized leader in Program management field.

Subfactor 2.3: Program Manager (“PM”) Has and Uses Interpersonal and Communications Skills. Poor interpersonal and communication skills. Interpersonal and communication skills not used effectively. Interpersonal and communication skills not used sufficiently. Interpersonal and communication skills sufficient but does not encourage synergy. PM's skills builds team's synergy & empowerment for highly motivated virtual teams. PM's skills builds team's synergy & empowerment and is effectively networked in the corporation and supply chain—expert in virtual self directed team skills.

Subfactor 2.4: Program Team is Sized and Staffed Appropriately. Team not defined. Large team, continuous size expansion, shortage of people of adequate abilities & high turnover. Large team has people of mixed abilities and high turnover. Large team has people of mixed abilities in each role. Team is staffed with the right people with the right abilities. Team has demonstrated success as same team on previous program excellent continuity.

Subfactor 2.5: Program Team Well Trained. Program team lack of training unrecognized. Program team untrained or operating in a highly volatile IT infrastructure. Program team trained in specialty skills and IT infrastructure. Program team trained/educated in program specific skills and infrastructure including virtual team effectiveness. Program team trained/educated in program specific skills and infrastructures for self directed virtual team effectiveness. Program team trained/educated in PM, business, program specific skills and infrastructures for self directed virtual team effectiveness; Program team used as an example in company—does training for others.

Subfactor 2.6: Program Team Member Selection Criteria and Background/Skills Alignment with Program Key Success Criteria. Team Members Selected based Solely Upon Currently Available Staff. Team Members Selected based Upon Currently Available Staff Prior to internal identification of Success Criteria. Team Members Selected based upon Currently Available Staff Prior to Stakeholder identification of Success Criteria. Several Key Team Members Selected based Upon Background/Skills Alignment with a few Stakeholder Key Success Criteria. All key Stakeholder Success Criteria are matched with best available internal team member backgrounds and skill sets. All key Stakeholder Success Criteria are matched with best available team member anywhere backgrounds and skill sets.

Subfactor 2.7: Communication Environment. No knowledge of tools to facilitate communication and collaboration. No use of tools to facilitate communication and collaboration. Poor reinforcement of virtual tools with appropriate face-to-face meetings. Operate as a integrated Product and Process team made up of the best local personnel. Team has member responsible for team communications and IT employment. Operates as a high performance virtual integrated Product and Process team made up of the best world-wide personnel—rare travel.

Subfactor 2.8: Delegation (Empowerment) from PM to Team Members. No understanding of needs for delegation. Under delegates to team members. Delegation of responsibilities and authorities thorough but management reviews/practices undercut empowerment. Clearly communicated delegation of responsibilities and authorities with continuous reviews to support empowerment. Clearly communicated delegation of responsibilities and authorities with collaborative reviews to support self directed team empowerment. PM willing to authorize violation of procedures when PM feels appropriate, and uses self directed empowered team environment to eliminate all rework.

As shown in FIG. 6, the subfactors contributing to the Program Management & Team Competence score for a program may each be evaluated against established bench marks. The subfactor scores may then be weighted according to program or organization specific criteria, or alternatively may be weighted against established or nominal weighted scores. The weight associated with each subfactor may be between 0 and 100%, though it has been found that nominal weighting factors for the program management and team competence subfactors with the following ranges are particularly useful for evaluating programs in the aviation and defense industries: Program Manager Experienced 2.1, weight of 9-29%; Program Manager Well Trained 2.2, weight of 0-19%; Program Manger Has and Uses Interpersonal and Communications Skills 2.3, weight of 4-24%; Program Team is Sized and Staffed Appropriately 2.4, weight of 9-29%; Program Team Well Trained 2.5, weight of 5-25%; Program Team Member Selection Criteria and Background Skills Aligned with Program Key Success Criteria 2.6, weight of 0-18%; Communication Environment 2.7, weight of 0-18%; Delegation (empowerment) from Program Manager to Team Members 2.8, weigh of 0-18%.

The combined aggregate weight of subfactors 2.1 through 2.8 should total 100%. The Program Manager & Team Competence category score may be calculated by multiplying the subfactor weight times the subfactor score for each subfactor and adding the results as indicated in the following formula:

PM Competence Score=(W_{2.1}*S_{2.1})+(W_{2.2}*S_{2.2})+(W_{2.3}*S_{2.3})+(W_{2.4}*S_{2.4})+(W_{2.5}*S_{2.5})+(W_{2.6}*S_{2.6})+(W_{2.7}*S_{2.7})+(W_{2.8}*S_{2.8})

In the implementation of FIG. 6, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

User/Customer Involvement & Expectations

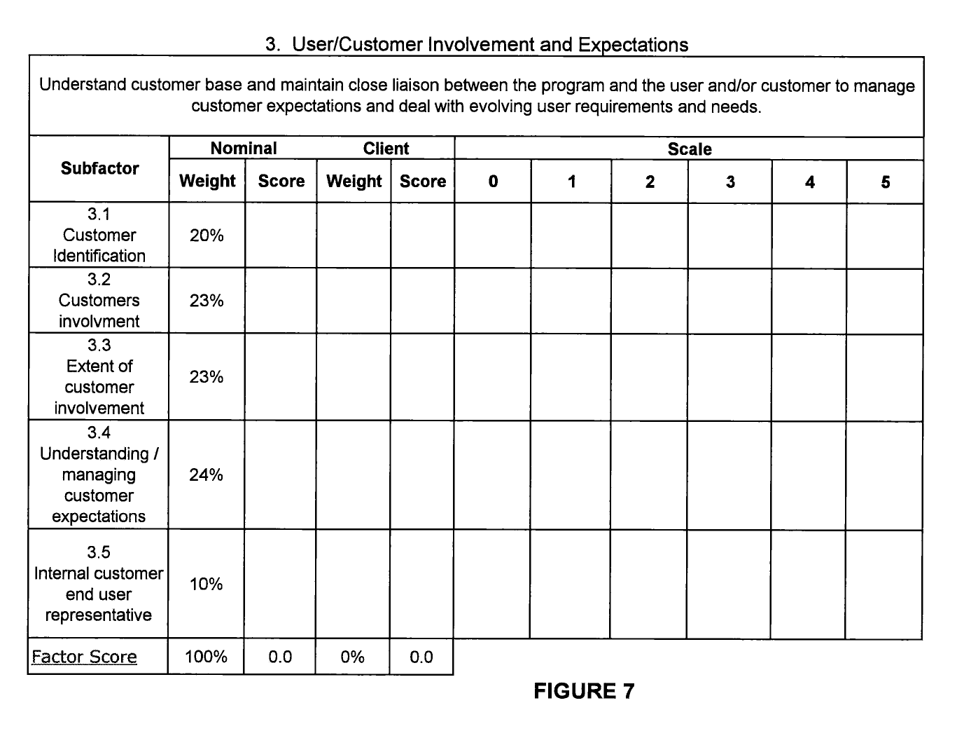

FIG. 7 provides an example of an illustrative score card relating to the User/Customer Involvement & Expectations Category. This category reflects the extent to which the program manager and team understand the customer base and maintain close liaison between the program and the user or customer. The category also addresses the extent to which customer expectations are managed and the ability of the program team to deal with and incorporate evolving customer requirements and needs. For example, within the aviation industry, program teams must involve pilots to obtain input to optimize human factors engineering considerations in cockpit design. And program teams designing new combat or weapons systems for the infantry must relate to and involve combat infantry personnel. It has been found that Program Management & Team Competence is dependent on one or more subfactors, which may comprise: Customer Identification, Customer Involvement; Extent of Customer Involvement, Understanding/Managing Customer Expectations; and Internal Customer End User Representative.

Referring to FIG. 6, the maturity of a program's use of customer involvement and ability to manage expectations may be determined by comparing the program of interest against certain benchmarks. For example, as previously described, a six point subfactor scoring continuum may be tailored to the User/Customer Involvement and Expectations category.

Subfactor 3.1: Customer Identification. Customer is Procurement Person. Customer is a Buying Agency. Customers are Agency Product and Process Organizations. Customers are Product and Process Organizations both External and internal. Customers now incorporate the using community over the life cycle of product. Customers are all Stakeholders with interest in the program outcome.

Subfactor 3.2: Customers involvement. Customer is not involved. Only customer interaction is responding to direct questions. Customer involved informally or are over-involved on multiple levels with no coordination. Customer actively involved in program but with interference or coordination issues. Customer actively involved in program without interference. User community and program team effectively operate as one seamless organization.

Subfactor 3.3: Extent of Customer involvement. No involvement. Customers informally and reactionarily involved. Customers periodically updated and consistently involved. Customers are providing Product & Process Expectations and Deliverables which are tracked during program execution through program closeout. Customers are involved seamlessly in team from program start with learning incorporated into the evolving program. Periodic direct contact between PM and Stakeholders to status program and update needs/requirements while incorporating learning based changes.

Subfactor 3.4: Understanding /managing customer expectations. No understanding of need to assess customer expectations. No attempt to assess customer expectations. Customer is not kept informed and expectations differ from PM team's. Customer is informed but expectations differ somewhat from PM team's. Customer and PM expectations aligned during periodic communication. Customer is embedded within the team with superb understanding of expectations through all work activities.

Subfactor 3.5: Internal customer end user representative. No customer representative or interaction. Customer representative has no experience as end user of system. Customer representative has some experience as end user of system. Customer representative is expert end user of system. Customer representative is expert end user of system with specialty engineering skills. Customer representative is expert end user of system with specialty engineering and PM skills.

As shown in FIG. 7, the subfactors contributing to the User/Customer Involvement and Expectations category score for a program may each be evaluated against established bench marks. The subfactor scores may then be weighted according to program or organization specific criteria, or alternatively may be weighted against established or nominal weighted scores. The weight associated with each subfactor may be between 0 and 100%, though it has been found that nominal weighting factors for the User/Customer Involvement and Expectations category subfactors with the following ranges are particularly useful for evaluating programs in the aviation and defense industries: Customer Identification 3.1, weight of 10-30%; Customer Involvement 3.2, weight of 13-33%; Extent of Customer Involvement 3.3, weight of 13-23%; Understanding/Managing Customer Expectations 3.4, weight of 14-34%; and Internal Customer End User Representative 3.5, weight of 0-20%.

The combined aggregate weight of subfactors 3.1 through 3.5 should total 100%. The User/Customer Involvement and Expectations category score may be calculated by multiplying the subfactor weight times the subfactor score for each subfactor and adding the results as indicated in the following formula:

Customer Inv. Score=(W_{3.1}*S_{3.1})+(W_{3.2}*S_{3.2})+(W_{3.3}*S_{3.3})+(W_{3.4}*S_{3.4})+(W_{3.5}*S_{3.5})

In the implementation of FIG. 7, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Learning Culture

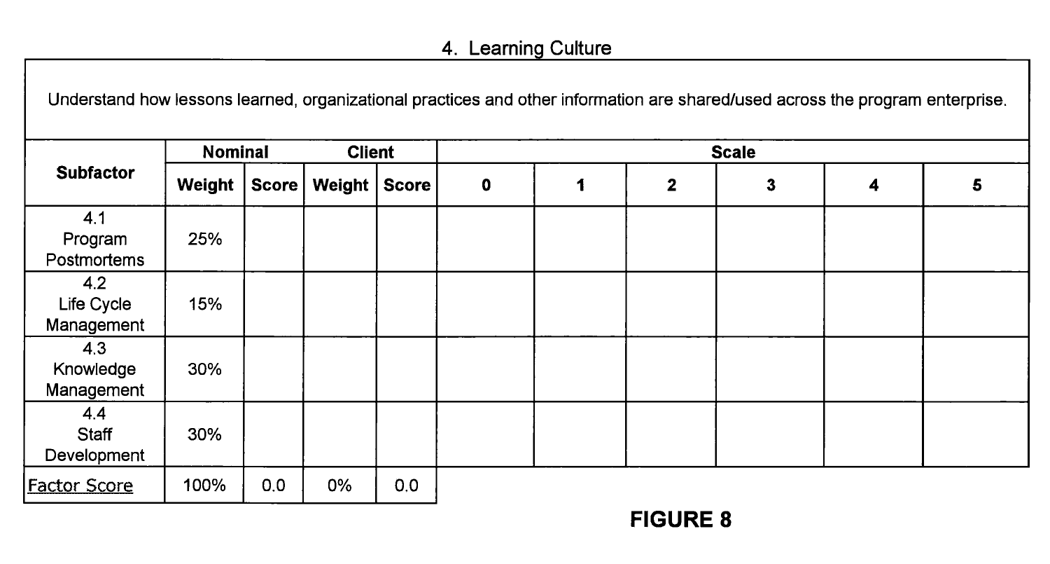

FIG. 8 provides an example of an illustrative score card relating to the Learning Culture critical performance area. This category reflects the extent to which the program manager and team foster a learning culture and use techniques to improve from past experience and leverage the organizational knowledge and know-how. For example, a program team commissioned to design and build an engine system for the space shuttle replacement spacecraft would be well served by capturing the experience and knowledge of veterans of the space shuttle program in order to understand how that program overcame early design challenges. And within any contractual program, a program team would benefit by understanding previously negotiated contractual terms and conditions with key contractors and sub-contractors in order to minimize negotiation delays. It has been found that an effective learning culture is dependent on one or more subfactors, which may comprise: program postmortems, life cycle management, knowledge management, and staff development.

Referring to FIG. 8, the maturity of a program's use of a learning culture may be determined by comparing the program of interest against certain benchmarks. For example, as previously described, a six point subfactor scoring continuum may be tailored to evaluate the subfactors attributed to the Learning Culture critical performance area.

Subfactor 4.1: Program Postmortems. None Performed. Significant losses drive executive-led postmortems. Occasional postmortems are performed, with by teams or specific processes. Entire program teams perform postmortems, but no uniform use of the knowledge gained. Organization uses postmortems drive process improvements and results of these improvements are included in future bids. Postmortems embedded in culture drive process improvements that reduce variations in program plan vs. execution.

Subfactor 4.2: Life Cycle Management. Life cycle issues are not identified or considered. Process specific component life cycle models are developed and employed on a limited basis. Organization specific product life cycle models are developed and employed on a limited basis. Organization specific product and process life cycle models are developed and employed on a limited basis with some verification. Enterprise product and process life cycle models are developed and employed on a limited basis with internal verification. Enterprise product and process life cycle models are developed, user verified and employed across the enterprise.

Subfactor 4.3: Knowledge Management. There is no formal knowledge management process. There is captured knowledge but not used; no incentives. Internal knowledge is captured and used on a limited, informal basis and incentives. Formal incentivized knowledge management program in place, use encumbered by ineffective or inefficient process. Formal knowledge management program in place and widely used, participation expected. Knowledge Management embedded in culture, drives continuous process improvement.

Subfactor 4.4: Staff Development. No formal training. Mandatory training based solely on organization compliance requirements. Mandatory training based employee's current position/job function. Individual training plan agreed upon between employee and supervisor. Formal employee learning plan coupled with mentoring process. Continuous formal mentoring process that is combined with a long term learning plan that is tied to life long career objectives.

As shown in FIG. 8, the subfactors contributing to the Learning Culture critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the Learning Culture critical performance area subfactors with the following ranges may be useful for evaluating programs in the aviation and defense industries: program postmortems 4.1, weight of 15-25%; life cycle management 4.2, weight of 5-25%, knowledge management 4.3, weight of 20-40%, and staff development 4.4, weight of 20-40%.

The combined aggregate weight of subfactors 4.1 through 4.4 should total 100%. The Learning Culture critical performance area score may be calculated by multiplying the subfactor weight times the subfactor score for each subfactor and adding the results as indicated in the following formula:

Learning Culture Score=(W_{4.1}*S_{4.1})+(W_{4.2}*S_{4.2})+(W_{4.3}*S_{4.3})+(W_{4.4}*S_{4.4})

In the implementation of FIG. 8, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Program Baseline Planning & Resourcing

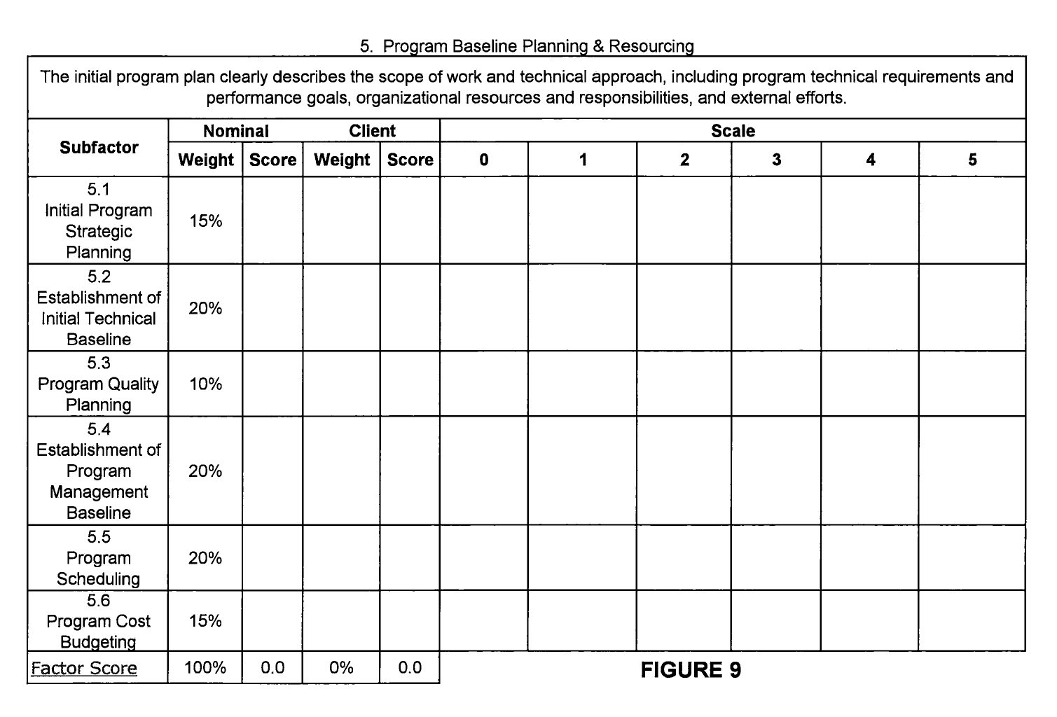

FIG. 9 provides an example of an illustrative score card relating to the Program Baseline Planning & Resourcing critical performance area. This category reflects the extent to which the program manager and team develop and execute an initial program plan that clearly describes the scope of work and technical approach of the program. For example, in a new aircraft development program, it is important to establish appropriate and realistic budgets to communicate the expected investment. It may also be important to budget for key systems engineering resources to identify potential resource and personnel constraints having an adverse impact on the program schedule. It has been found that effective baseline planning and resourcing is dependent on one or more subfactors, which may comprise: initial program strategic planning; establishment of initial technical baseline; program quality planning; establishment of program management baseline; program scheduling; and program cost budgeting.

Referring to FIG. 9, the maturity of a program's baseline planning may be determined by comparing the program of interest against certain benchmarks. For example, as previously described, a six point subfactor scoring continuum may be tailored to evaluate the subfactors attributed to the Program Baseline Planning & Resourcing critical performance area.

Subfactor 5.1: Initial Program Strategic Planning. No strategic planning; contractor accepts the contract and complies with requirements. Cash flow and other strategic planning after contract award. Cash flow and other strategic planning during proposal/bid phase; contract-aligned to maximize cash flow; integration of critical subs into baseline planning; technical staff implements risk mgmt. strategies for SOW evolution to identify resulting variances. Integration of all key vendors (based on risk) into proposal planning and program integrated baseline, long-term planning includes strategy to manage SOW evolution based on changing customer needs (ECP). Contract aligned to support SOW evolution and to incentivize management of SOW evolution to meet changing customer needs (VE). PM team has ability to identify SOW opportunities to customer both before and during contract performance. Program team completely integrated on every level, including maximum integration with customer and end user;s ability to influence solicitation requirements.

Subfactor 5.2: Establishment of Initial Technical Baseline. Technical baseline not formally established or not well communicated to PM team. Technical baseline is established and tied to contract SOW. Technical baseline is established and tied to contract SOW; technical evolution and resulting variances can be identified as they occur. Technical baseline is established and fully integrated into PMB; includes technical risk management and contingency planning. Technical baseline includes post-contract planning and production capability planning. Technical baseline integrates evolving SOW to meet production needs and incorporates life-cycle management concepts.

Subfactor 5.3: Program Quality Planning. No planning. Quality issues are addressed as exceptions. Formal quality program integrates quality planning into processes; an independent QC function inspects and identifies exceptions. Quality Controls and inspection are incorporated into program planning and processes; inspection is embedded not independent. Self-inspection with process improvement programs in place, overseen by embedded QC professionals. Rigorous process improvement with continuous improvement goals integrated into all processes; QC is not a separate discipline.

Subfactor 5.4: Establishment of Program Management Baseline. No formal PMB planning process, requirements, or standards. PMB planning includes separate cost & schedule elements via COTS system. PMB integrates organization roles/resources, contract milestones, and cost & schedule using a standard approach/template. Integrated PMB is part of a standard formal process that complies with the 32 standards of ANSI EIA-748-A and includes risk management/contingency planning. Integrated PMB is part of a mature EMVS system that has been validated; IBRs routinely conducted; subs and vendors participate. IBRs validate assumptions against prior program history; state-of-the-art EVMS in use, risk management embedded into PMB and IBR; subs and vendors fully integrated.

Subfactor 5.5: Program Scheduling. Basic high level scheduling (Gantt Chart) with no CPM ability and no interdependence; responsible organization elements not identified. Schedule broken into key discrete tasks with responsible org. elements identified; no CPM, no interdependence. Key discrete tasks are sequenced and logically liked to show CPM and interdependencies; all physical products and contract milestones are embedded. Program broken into granular tasks that roll-up to high level tasks (fully integrated); subcontractors and vendors are identified but not integrated into schedule. Fully integrated, granular, schedule includes all external parties; schedule analysis includes near-CPM and contingency planning. Schedule is integrated with customer; complete integration facilitates management analysis/action; contingency planning from customer to lowest-tier vendor; schedule issues identified; addressed before occurrence.

Subfactor 5.6: Program Cost Budgeting. No formal PMB planning process, budgets or standards. Cost and schedule separately planned using COTS system; budgets by task tied to contract; informal management reserve. PMB integrates cost & schedule, organization roles/resources, and all contract milestones using a standard resource-loaded approach/template; task budgets identify original bid as well as negotiated contract amounts. Integrated PMB is part of a standard process that complies with the 32 standards of ANSI EIA-748-A & includes risk management/contingency planning; manpower/resource needs costed (bottoms up) and compared to budgets to identify issues. Integrated PMB is part of a mature EVMS system that has been validated; IBRs routinely conducted; subs and vendors participate; PMB drives near-term resource management. IBRs validate assumptions against prior programs; state-of-the-art EVMS in use, risk management embedded into PMB and IBR; subs and vendors fully integrated; potential cost variances identified/addressed before incurrence.

As shown in FIG. 9, the subfactors contributing to the Program Baseline Planning & Resourcing critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the Program Baseline Planning & Resourcing critical performance area subfactors with the following ranges may be useful for evaluating programs in the aviation and defense industries: initial program strategic planning 5.1, weight of 5-25%; establishment of initial technical baseline 5.2, weight of 10-30%; program quality planning 5.3, weight of 0-20%; establishment of program management baseline 5.4, weight of 10-30%; program scheduling 5.5 weight of 10-30%; and program cost budgeting 5.6, weight of 5-25%. The combined aggregate weight of subfactors 5.1 through 5.6 should total 100%.

The Program Baseline Planning & Resourcing critical performance area score may be calculated by multiplying the subfactor weight times the subfactor score for each subfactor and adding the results as indicated in the following formula:

Baseline Planning Score=(W_{5.1}*S_{5.1})+(W_{5.2}*S_{5.2})+(W_{5.3}*S_{5.3})+(W_{5.4}*S_{5.4})+(W_{5.5}*S_{5.5})+(W_{5.6}*S_{5.6})

In the implementation of FIG. 9, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Change Management

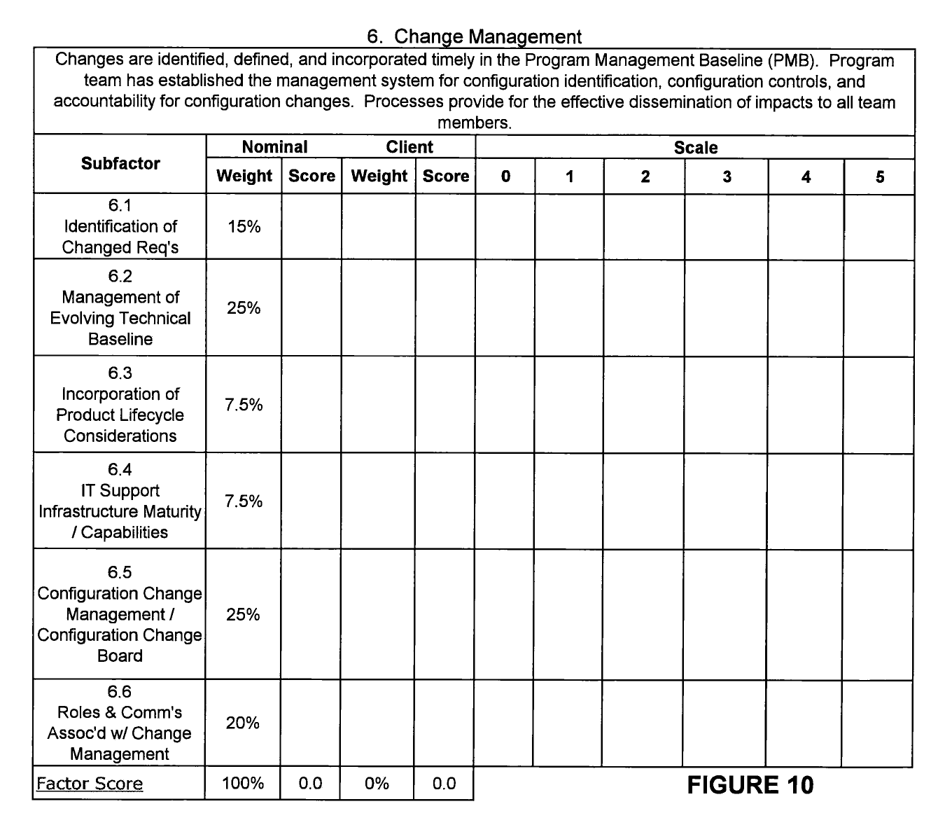

FIG. 10 provides an example of an illustrative score card relating to the Change Management critical performance area. This category reflects the extent to which the program manager and team incorporate, account for and communicate changes within the program plan. For example, promptly an accurately identifying impacts to budgets and schedules associated with pending and/or approved changes to contracts, such as adding armor to vehicles in a pre-existing manufacturing contract. Another example of change management proficiency is the ability to keep all component drawing configurations current throughout the production and delivery cycle. It has been found that effective change management is dependent on one or more subfactors, which may comprise: identification of changed requirements; management of evolving technical baseline; incorporation of product lifecycle considerations; information technology support infrastructure maturity/capabilities; configuration change management/configuration change board; roles and communications associated with change management.

The maturity of a program's change management system may be determined by comparing the program of interest against certain benchmarks. For example, as previously described, a six point subfactor scoring continuum may be tailored to evaluate the subfactors attributed to the Change Management critical performance area.

Subfactor 6.1: Identification of Changed Requirements. No method or process for identifying, reporting, or tracking changed requirements. Informal change process dependent upon individual program members. Informal change process implemented program-wide, but results in untimely change identification, notification. Program changes tied to customer SOW and coordinated with physical/plant processes. Customer and third parties involved in discussions to clarify, establish, and approve changes timely. Direct communication with the customer, end user, and third parties to enable timely incorporations or adaptations to changed mission needs and user requirements.

Subfactor 6.2: Management of Evolving Technical Baseline. No changes to initial technical baseline. Technical baseline frozen at program start. Configuration management applied to defined part of technical baseline evolution. Configuration management applied to fully defined technical baseline evolution. Internal on-line access to management configuration of fully defined technical baseline evolution during work hours. Enterprise on-line access to managed configuration of fully defined technical baseline evolution with 24/7 access.

Subfactor 6.3: Incorporation of Product Lifecycle Considerations. Each phase of program deals only with current phase issues. Only next phase requirements incorporated into program; unaware of product lifecycle after next phase. Program awareness of all lifecycle issues; not incorporated to influence product. Program familiarity with all lifecycle issues; selected influences incorporated into product. Product lifecycle fully modeled and all aspects of the product have been tailored for lifecycle goals. Product lifecycle fully modeled and validated with users.

Subfactor 6.4: IT Support Infrastructure Maturity/Capabilities. Universal e-mail access to all program entities. Hardware and software incompatibilities for data exchange overcome by small bandwidth LANs, data translations and CD distribution. Internal hardware and software standards with high speed networks leave external data exchanges by crude means. Architecturally compatible hardware and software with high speed internet conductivity enable most data to be exchanged and virtual team functionality with security issues. Architecturally compatible hardware and software with high speed internet conductivity enable all data exchanges and fully virtual team collaboration. Advanced database technologies and ontologies enable full real time collaboration, business subsystem integration, and full permission based access to distributed federated data archiving and knowledge system warehousing.

Subfactor 6.5: Configuration Change Management/Configuration Change Board. No formal change management process. Change management process not followed. Change management process does not contain full set of management rules; rationale not documents. Contract changes are rapid and visible when needed; rationale document and communicated. All changes reflected in contract; decisions coordinated with stakeholders; parties understand and concur with changes. On-line program requirements incorporated into a living document with traceable history and links to the PMB.

Subfactor 6.6: Roles & Communications Associated with Change Management. Changes made without PM or contract administration involvement. PM negotiates and authorizes all changes with informal communication links to contract administration. PM and contracts administration jointly negotiate and authorize all contract changes. All contract and customer commitments are linked; configuration managed on-line with all internal team member access with changes requested by anyone but negotiated jointly by PM and Contracts administrator. Supply chain is linked and changes flow electronically between all tiers of program team; suppliers can request changes.

As shown in FIG. 10, the subfactors contributing to the Requirements & Change Management critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the Requirements & Change Management critical performance area subfactors with the following ranges may be useful for evaluating programs in the aviation and defense industries: identification of changed requirements 6.1, weight of 5-25%; management of evolving technical baseline 6.2, weight of 15-35%; incorporation of product lifecycle considerations 6.3, weight of 2-18%; information technology support infrastructure maturity/capabilities 6.4, weight of 2-18%; configuration change management/configuration change board 6.5, weight of 15-35%; roles and communications associated with change management 6.6, weight of 10-30%. The combined aggregate weight of subfactors 6.1 through 6.6 should total 100%.

The Program Baseline Planning & Resourcing critical performance area score may be calculated by multiplying the subfactor weight times the subfactor score for each subfactor and adding the results as indicated in the following formula:

Baseline Planning Score=(W_{6.1}*S_{6.1})+(W_{6.2}*S_{6.2})+(W_{6.3}*S_{6.3})+(W_{6.4}*S_{6.4})+(W_{6.5}*S_{6.5})+(W_{6.6}*S_{6.6})

In the implementation of FIG. 10, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Performance Measurement & Program Execution

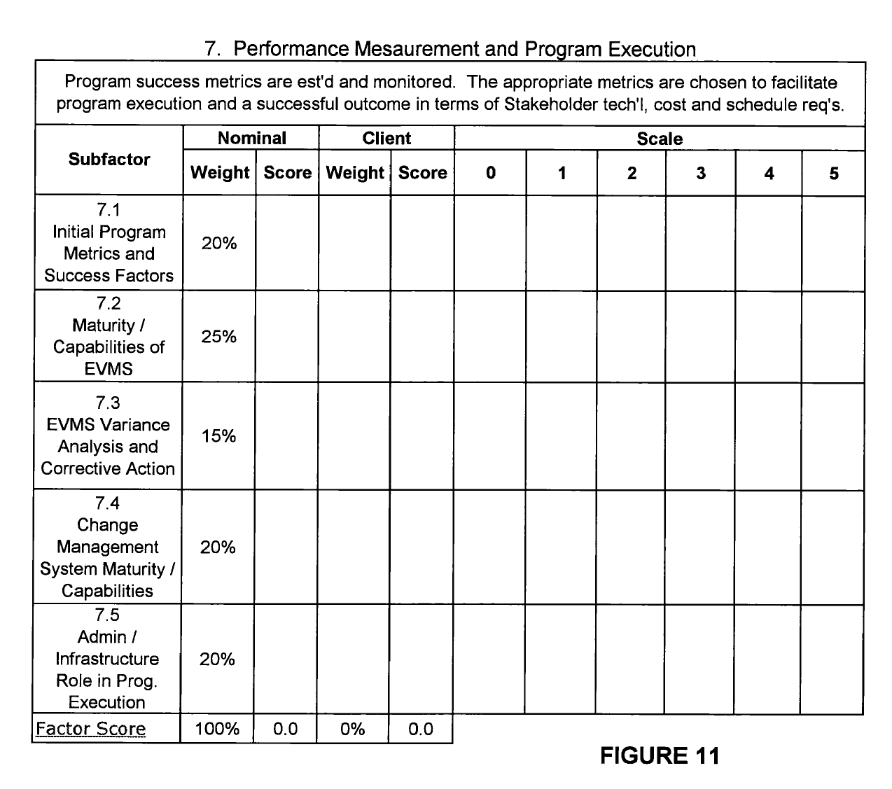

FIG. 11 provides an example of an illustrative score card relating to the Performance Measurement & Program Execution critical performance area. This category reflects the extent to which the program manager and team establish and monitor meaningful program metrics to facilitate program execution. For example, a new satellite development program may implement the requirements of the American National Standards Institute/Electronic Industries Alliance (ANSI/EIA) Standard 748-A. Also, a new aircraft carrier program may develop an Integrated Master Plan/Integrated Master Schedule in accordance with the Department of Defense IMP/IMS Preparation and Use Guide. It has been found that effective performance measurement & program execution is dependent on one or more subfactors, which may comprise: establishment of initial program metrics and success factors; maturity capabilities of earned value management system (EVMS); EVMS variance analysis and corrective action; change management system maturity/capabilities; and administration infrastructure role in program execution.

The maturity of a program's performance measurement and program execution system may be determined by comparing the program of interest against certain benchmarks. For example, as previously described, a six point subfactor scoring continuum may be tailored to evaluate the subfactors attributed to the Performance Measurement & Program Execution critical performance area.

Subfactor 7.1: Establishment of Initial Program Metrics and Success Factors. No establishment of program metrics, no formal, measurable definition of success. Program access equals on-spec. on-time; on-budget at completion; no interim monitoring. Various program metrics (technical, cost, schedule) established at kick-off and monitored regularly. Program success factors/metrics include vendors/subs, cash management, other balanced scorecard metrics. Regularly monitored by management and results are disseminated to program team. Customer and end-user success factors included and customer is involved in monitoring of results. Success factors/metrics aligned with strategic goals; metrics, monitoring & results fully integrated from lowest tier sub to customer & end-user; web-enabled monitoring.

Subfactor 7.2: Maturity/Capabilities of Earned Value Management System (EVMS). No EVMS; nor formal measurement of cost/schedule progress; no routine monitoring for cost/schedule variances. Basic EVMS using COTS system; little or no linkage to ANSI EIA-748-A; monitoring & reporting quarterly or less often. Formal EVMS per written system description; compliant with ANSI EIA-748-A; monthly monitoring/reporting; basic systems. EVMS has been validated by Government; monthly monitoring/reporting with ACWP updated each pay period; custom systems. Management conducts rigorous IBRs; on-line systems with auto updates; integrated with financial and other management systems; vendors/subs integrated. Customer integrated and participates in IBRs, monthly reviews; web-enabled access to all team members from lowest tier sub to customer/end-user.

Subfactor 7.3: EVMS Variance Analysis and Corrective Action. No variance analysis. Interim analysis of ACWP against Budget; little or no rigorous at-completion analysis. Rigorous EVMS analysis monthly; variances identified by task and responsible org. element; periodic at-completion analysis. Monthly EVMS analysis (including CPI/SPI) with required root cause/corrective action plans & mgmt. follow-up; rigorous at-completion analysis at least quarterly. Vendors/subs integrated and performing variance analysis and at completion analysis; interim variances automatically prompt management action and at-completion analyses. EMVS integrated from sub to customer, with on-line access; near real-time update and variance analysis; variances prompt timely corrective action; independent evaluation of VACs and EACs.

Subfactor 7.4: Change Management System Maturity/Capabilities. Changes identified via receipt of contract modification; no ability for cost segregation by change order; little or no ability to update PMB for changes. LREs and VACs prompt ID of changes; little or no cost ID/segregation by change order; customer notified late or not at all; PMB may be changed infrequently with great difficulty. EVMS variances prompt ID of changes; post hoc customer notification; PMB updated as required through formal rebaselining. Change control discipline in place; customer notified promptly (often before costs are incurred); PMB updated as changes are authorized approved. Vendors/subs included in change control methodology; VECP, ECP, and REA discipline in place; PMB tracks authorized, funded and unsettled changes and is updated frequently. State-of-the-art change control with full integration from lowest tier sub to customer & end-user; on-line tracking of all changes (including separate BOMs) with robust reporting capabilities; changes generate cascade impacts to all linked tasks.

Subfactor 7.5: Administration/Infrastructure Role in Program Execution. Admin. personnel in separate silos; not included in Program Team. Some admin personnel part-time matrixed to program from central support or shared services group; little or no accountability to program. Admin personnel matrixed to Program Team, reporting to Program Manager (dotted line); PM must interface with various admin leaders to manage resources and activities of admin/infrastructure support personnel. Program Management includes Deputy or Business Manager who interfaces with various admin leaders; DPM/BM has input into admin. personnel reviews & merit increases to assure accountability. Admin. Personnel report to DPM/BM, who manages day-to-day activities and resource loading and has authority to review performance and reassign personnel as necessary. All admin & infrastructure disciplines represented on Program; reporting to Program Management Team and fully integrated with little or no evidence of silos.

Subfactor: As shown in FIG. 11, the subfactors contributing to the Performance Measurement & Program Execution critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the Performance Measurement & Program Execution critical performance area subfactors with the following ranges may be useful for evaluating programs in the aviation and defense industries: establishment of initial program metrics and success factors 7.1, weight of 10-30%; maturity capabilities of earned value management system (EVMS) 7.2, weight of 15-25%; EVMS variance analysis and corrective action 7.3, weight of 5-25%; change management system maturity/capabilities 7.4, weight of 10-30%; and administration infrastructure role in program execution 7.5, weight of 10-30%. The combined aggregate weight of subfactors 7.1 through 7.5 should total 100%.

The performance measurement and program execution critical performance area score may be calculated by multiplying the subfactor weight times the subfactor score for each subfactor and adding the results as indicated in the following formula:

Perf. Meas. Score=(W_{7.1}*S_{7.1})+(W_{7.2}*S_{7.2})+(W_{7.3}*S_{7.3})+(W_{7.4}*S_{7.4})+(W_{7.5}*S_{7.5})

In the implementation of FIG. 11, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Risk Management

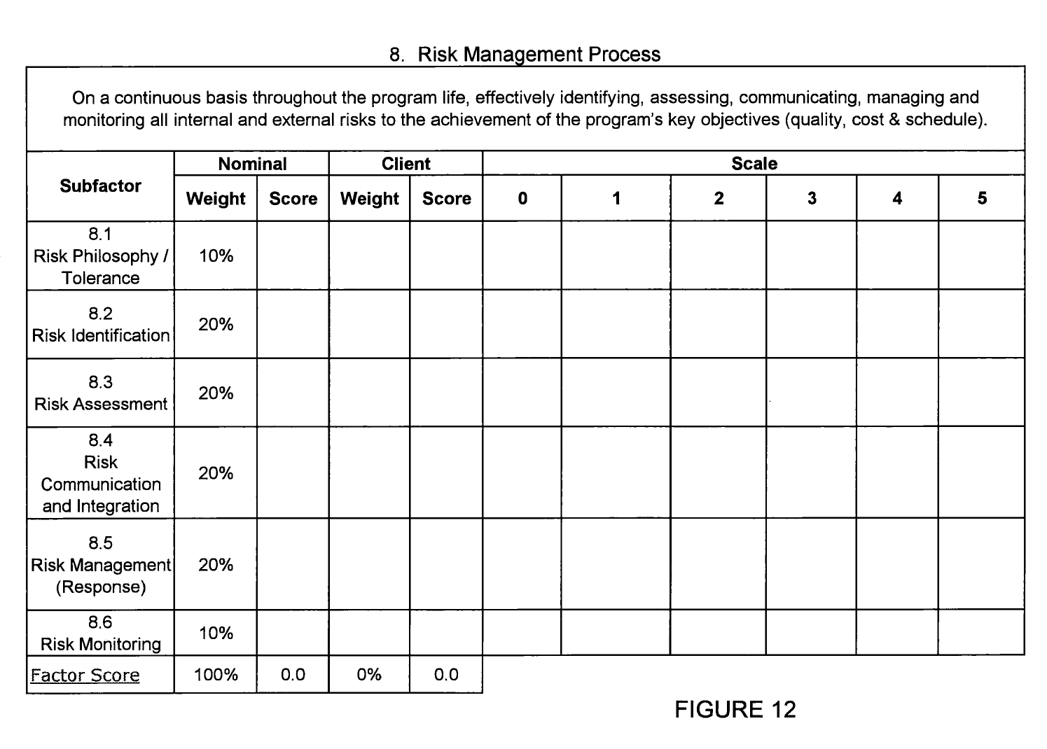

FIG. 12 provides an example of an illustrative score card relating to the Risk Management critical performance area. This category reflects the extent to which the program manager and team identify, assess, communicate, monitor and manage internal and external risks throughout the program life. Risk may be any influence that impacts a program's key objectives, including, but not limited to, impacts on cost, quality, and schedule. For example, it may be necessary to identify and manage alternate sources of supply for critical specialty metals for use in satellites to mitigate potential manufacturability problems by the chosen supplier. Also, risk may be mitigated by ensuring that all aircraft design subcontractors use the same design software to mitigate the risk of design errors. A defense contractor may be required to implement the Department of Defense Risk Management Guide in the planning of a new munitions program. It has been found that effective risk management is dependent on one or more subfactors, which may comprise: risk philosophy or tolerance; risk identification; risk assessment; risk communication and integration; risk management and response; and risk monitoring.

The maturity of a program's risk management may be determined by comparing the program of interest against certain benchmarks. For example, as previously described, a six point subfactor scoring continuum may be tailored to evaluate the subfactors attributed to the risk management critical performance area.

Subfactor 8.1: Risk Philosophy/Tolerance. No shared risk philosophy/tolerance exists. Management has views on risk philosophy and tolerance, but does not communicate to organization. Various program metrics (technical, cost, schedule) established at kick-off and monitored regularly. Management has formulated views on risk philosophy and tolerance and has communicated to organization, but compliance is not enforced. Risk limits by staff level and organizational unit are in place, aligned to risk tolerance,. Overall integrated/portfolio view of enterprise risk profile is compared to risk tolerance to ensure net position is acceptable.

Subfactor 8.2: Risk Identification. No risk identification process or activities. Risk are identified, but the process is ad hoc or informal; no common definition of risk or agreed scope (breadth of risk event categories). Risks are periodically identified through structured events; lack of common definition, scope and approach leads to inadequate risk identification. Entity uses a common definition and comprehensive scope. The program manager updates risk identification perpetually throughout the program's life cycle. Risk identification by specialists not integrated with Program Team. Risk identification is a collaborative process and is the responsibility of each process owner. Collaboration includes supply chain and is good within functional silos, but gaps exist at interdepartmental hand-offs. All stakeholders participate in risk identification. Strong collaboration occurs across the value chain.

Subfactor 8.3: Risk Assessment. All risks are created equal. Risks are assessed on a simple, “gut instinct”, H-M-L basis. Risks are measured subjectively on a rudimentary quantitative basis (e.g., order of magnitude). Likelihood is not considered. An attempt is made to monetize risk events, but process is inconsistent. Likelihood is considered, but not based on inherent risk (i.e., based on assumed strength of controls). Risks are rigorously quantified using a common methodology. Likelihood is assessed based on inherent risk. No validation of mitigating controls. Mitigating controls validated periodically.

Subfactor 8.4: Risk Communication and Integration. No communication or integration of risk positions. Once risks are identified and assessed, they are reported upward, but limited feedback provided. Upward reporting occurs and feedback provided; risks are considered individually and not on a consolidated basis. Risks are consolidated across the Program. Program not linked to enterprise. Integrated/enterprise portfolio view of risk is utilized. Periodic feedback to risk owners. Enterprise risks linked to suppliers and customers. Timely communication of risk disposition throughout all Stakeholders.

Subfactor 8.5: Risk Management (Response). Risk's ID'd and assessed, but discussion ends with no agreed response. Informal or ad hoc risk response process. Formal risk response process, but responses lack alignment to established tolerance levels. Risk responses aligned to established tolerance levels. Risk responses formulated collaboratively across the enterprise, considering consolidated risk positions. Risk responses formulated with input from supply chain and customer/end-users.

Subfactor 8.6: Risk Monitoring. No monitoring. Ad hoc or informal surveillance with limited testing of individual risk responses. A systematic process of determining which risks merit on-going monitoring and testing. Overall risk management process not monitored. Overall risk management process is monitored. Leading indicators for key risks have been identified and are monitored as an early warning system. Leading indicators deployed throughout supply chain and with customer/end-user. Technology enablers provide near real-time notification.

As shown in FIG. 12, the subfactors contributing to the risk management critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the risk management critical performance area subfactors with the following ranges may be useful for evaluating programs in the aviation and defense industries: risk philosophy or tolerance 8.1, weight of 0-20%; risk identification 8.2, weight of 10-30%; risk assessment 8.3, weight of 10-30%; risk communication and integration 8.4, weight of 10-30%; risk management and response 8.5, weight of 10-30%; and risk monitoring 8.5, weight of 0-20%. The combined aggregate weight of subfactors 8.1 through 8.6 should total 100%.

The risk management critical performance area score may be calculated by multiplying the subfactor weight times the subfactor score for each subfactor and adding the results as indicated in the following formula:

Risk Management Score=(W_{8.1}*S_{8.1})+(W_{8.2}*S_{8.2})+(W_{8.3}*S_{8.3})+(W_{8.4}*S_{8.4})+(W_{8.5}*S_{8.5})+(W_{8.6}*S_{8.6})

In the implementation of FIG. 12, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Alignment of Goals & Objectives

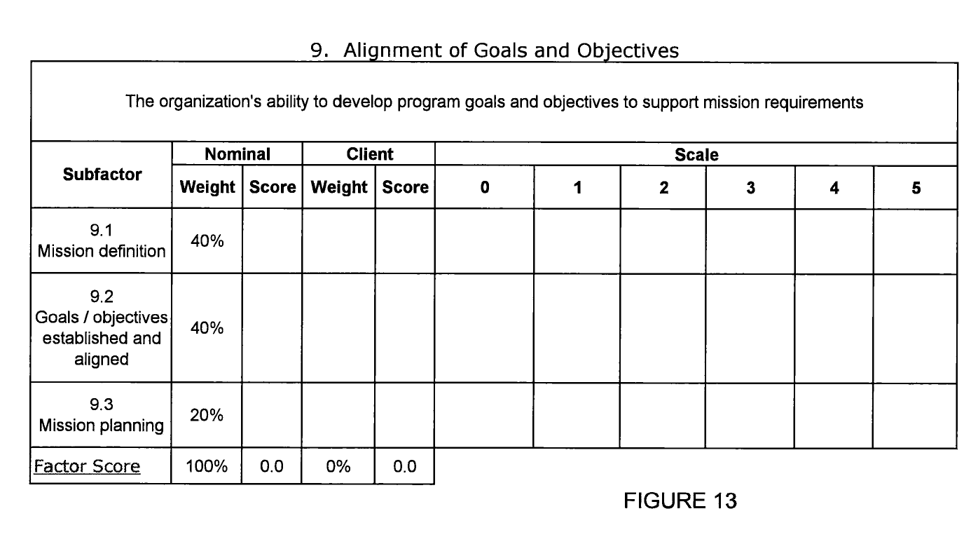

FIG. 13 provides an example of an illustrative score card relating to the Alignment of Goals & Objectives critical performance area. This category reflects the extent to which the program manager and team develop program goals and objectives to support mission requirements. For example, it may be critical to ensure that the Littoral Combat Ship program budgets are consistent with the Defense Contract Management Agency appropriated funds values. Also, establishing negotiated profit rates for a laser propagation study based on corporate internal hurdle rates, as opposed to what the client is willing to pay, ensures profitability alignment with the larger organization. It has been found that effective risk management is dependent on one or more subfactors, which may comprise: mission definition; goals or objectives established and aligned; and mission planning.

The maturity of a program's alignment of goals and objectives with mission requirements may be determined by comparing the program of interest against certain benchmarks. For example, as previously described, a six point subfactor scoring continuum may be tailored to evaluate the subfactors attributed to the risk management critical performance area.

Subfactor 9.1: Mission definition. No understanding of mission definition. Limited to control requirements. Mission defined based on perceived needs of immediate buyer. Mission defined based on perceived needs of the program. Mission tied to end user's need. Mission evolves with changes in the end user's environment.

Subfactor 9.2: Goals/objectives established and aligned. Contract specified goals and objectives; no attempt to align stakeholders. Goals and objectives are established by internal process owner; stakeholder goals in conflict. Program team goals and objectives are established and internally aligned; separation from enterprise and external priorities. Program team, enterprise and customer goals and objectives are established and aligned through nonrecurring meeting. All stakeholders aligned & priorities with through periodic communication. Seamless integration and alignment from individuals through the end-user; creates synergies and efficiencies.

Subfactor 9.3: Mission planning. No effort to made to anticipate. States learn separately attempts to identify future opportunities. Program team and sales team work together to identify future opportunities. Enterprise devotes significant resources to identification of future customer needs. R&D spending aligned with potential future missions. Enterprise aligned with end-users to identify evolving needs and positions organization to meet those needs.

As shown in FIG. 13, the subfactors contributing to the Mission Alignment of Goals & Objectives critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the Mission Alignment of Goals & Objectives critical performance area subfactors with the following ranges may be useful for evaluating programs in the aviation and defense industries: mission definition 9.1, weight of 30-50%; goals or objectives established and aligned 9.2, weight of 30-50%; and mission planning 9.3, weight of 10-30%. The combined aggregate weight of subfactors 9.1 through 9.6 should total 100%.

The Mission Alignment of Goals & Objectives critical performance area score may be calculated by multiplying the subfactor weight times the subfactor score for each subfactor and adding the results as indicated in the following formula:

Alignment Score=(W_{9.1}*S_{9.1})+(W_{9.2}*S_{9.2})+(W_{9.3}*S_{9.3})

In the implementation of FIG. 13, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Proposal Preparation

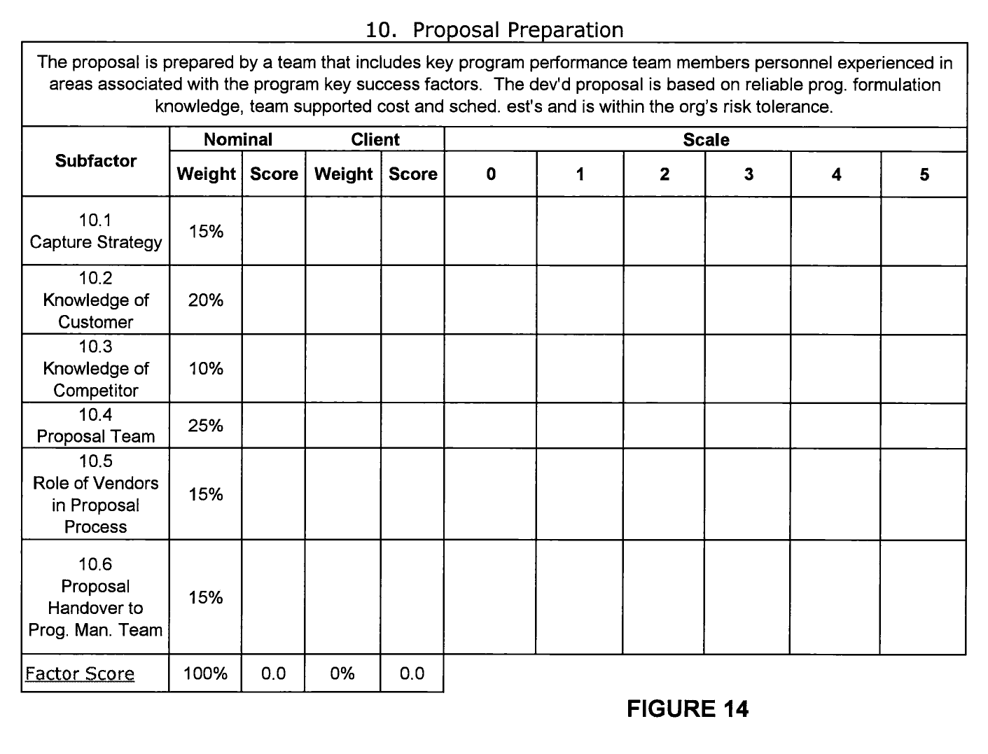

FIG. 14 provides an example of an illustrative score card relating to the Proposal Preparation critical performance area. This category reflects the extent to which the program manager and team prepare program proposals based on reliable program formulation knowledge, team supported costs and schedules estimates and within the organization's risk tolerance. The category also reflects the extent to which the proper personnel are involved in program proposal generation. For example, the Department of Defense Quadrennial Review can be used to identify future sales opportunities and can be incorporated into a strategic marketing plan. Soliciting input from critical suppliers may be necessary to ensure manufacturability and deliverability. For example, a new rocket engine program may benefit from input of precision casting suppliers in the proposal stage. It has been found that effective proposal preparation is dependent on one or more subfactors, which may comprise: capture strategy; knowledge of the customer; knowledge of the competitor; proposal team; role and relationship of the vendors in the proposal process; and proposal handover to program management team.

Referring to FIG. 14, the maturity of a program's proposal preparation may be determined by comparing the program of interest against certain benchmarks. For example, as previously described, a six point subfactor scoring continuum may be tailored to evaluate the subfactors attributed to the proposal preparation critical performance area.

Subfactor 10.1: Capture Strategy. No process for monitoring solicitations; no awareness of opportunities; no customer interaction; opportunities appear as a surprise. Ad hoc capture strategy based on leveraging existing programs and their customer relationships. Informal process for monitoring program opportunities by individuals; identification of opportunity triggers bid-no bid and creation of proposal team; proposal team formulates capture strategy. Organized process for early identification of opportunities; bid/no bid decision aligned with enterprise strategy; capture team resources dedicated; capture team has strategy in place prior to formal solicitation. Capture team integrated across the enterprise; proposed performance team (including vendors) cohesive and aligned; active communication links with customers facilitates influencing of solicitation. Capture team influencing the customer's recognition of its own needs; vendors seek us out in recognition of our position with stakeholders.

Subfactor 10.2: Knowledge of Customer. No understanding; no customer relationships. Aware of customer sensitivities and needs; capture process not aligned to customer evaluation process. Capture process aligned with RFP requirements; customer knowledge based solely upon past performance with customer. Customer knowledge enables internal “Red Team” to be established to effectively act as customer. “Red Team” includes external subject matter experts and supply chain; capture team uses enhanced knowledge of customer and customer processes to gain competitive advantage. Customer relationships and past performance create opportunities for sole source awards.

Subfactor 10.3: Knowledge of Competitor. No knowledge of competitors; bidders list contains surprises. Competitors known; no ability to assess relative strengths and weaknesses. High level, public information sources for relative comparisons of and to competitors. A formal or rigorous competitor assessment conducted by marketing as part of bid/no bid decision. RFP evaluation factors used as framework for rigorous competitive analysis and identification of weaknesses to be addressed in proposal. Accurate insights into competitors facilitate early remediation of relative weaknesses through hiring personnel or teaming.

Subfactor 10.4: Proposal Team. Proposal team established after receipt of RFP; team consists of personnel not otherwise utilized. Proposal team established after receipt of RFP; team consists of experienced personnel very familiar with proposal preparation. Proposal team established when draft RFP released or prior to release of RFP; proposal team includes dedicated, full-time professional proposal team members. Proposal team linked to capture team; functional leads involved in forming proposed approach. Proposal team identified as part of initial capture strategy; appropriate administrative and technical resources seconded to proposal team. Proposal team fully embedded into capture team process; proposal team includes key members of negotiation and post award program execution teams.

Subfactor 10.5: Role and Relationship of Vendors in Proposal Process. Vendor planning not initiated until after receipt of contract award. Vendor planning initiated after receipt of RFP. Vendor planning initiated prior to receipt of RFP released; critical vendors provide input into establishing proposed baseline (cost schedule technical). Key vendors linked to proposed program via formal agreement (e.g., teaming agreement); vendor budget and schedule negotiations initiated prior to submission of proposal. Vendors included in capture team process; vendors actively participate with members of proposal, negotiation, and post award program execution teams.

Subfactor 10.6: Proposal Handover to Program Management Team. Program management team appointed after contract award; little or no hand-off from proposal team. Proposal files documented ad hoc or informally; key program management personnel identified prior to proposal submission; others not identified until after contract award. Proposal team documents business case and proposed baseline; proposal files provided to program management team after award. Hand-off process is executed against formal policy/practice. Key program management team personnel participate in proposal process and reviews/approves proposed commitments to customer. Enterprise has seamless, transparent hand-off between proposing, negotiating, and performing teams; program management personnel participate in negotiations; knowledge management embedded in culture.

As shown in FIG. 14, the subfactors contributing to the Proposal Preparation critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the Proposal Preparation critical performance area subfactors with the following ranges may be useful for evaluating programs in the aviation and defense industries: capture strategy 10.1, weight of 5-25%; knowledge of the customer 10.2, weight of 10-30%; knowledge of the competitor 10.3, weight of 0-20%; proposal team 10.4, weight of 15-35%; role and relationship of the vendors in the proposal process 10.5, weight of 5-25%; and proposal handover to program management team 10.6, weight of 5-25%. The combined aggregate weight of subfactors 10.1 through 10.6 should total 100%.

The Proposal Preparation critical performance area score may be calculated by multiplying the subfactor weight times the subfactor score for each subfactor and adding the results as indicated in the following formula:

Proposal Prep. Score=(W_{10.1}*S_{10.1})+(W_{10.2}*S_{10.2})+(W_{0.3}*S_{10.3})+(W_{10.4}*S_{10.4})+(W_{10.5}*S_{10.5})+(W_{10.6}*S_{10.6})

In the implementation of FIG. 14, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Process Alignment

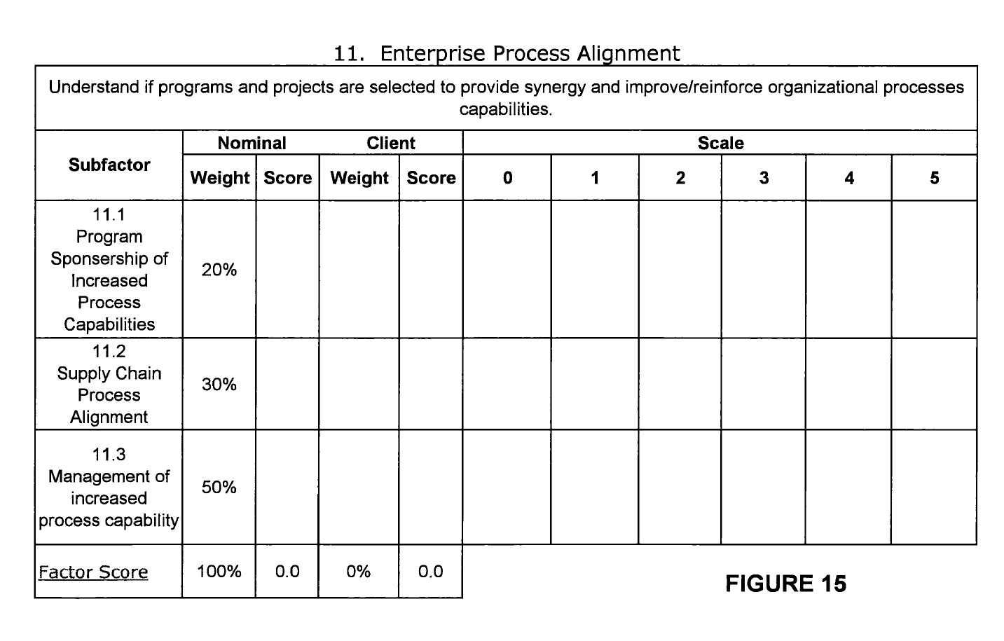

FIG. 15 provides an example of an illustrative score card relating to the Process Alignment critical performance area. This category reflects the extent to which the program manager and team understand the selection process at the enterprise level of programs and the extent to which selected programs provide synergy and improve or reinforce organizational processes and capabilities. For example, in order to optimize the engine assembly process for a new commercial airplane, the program team could ensure regular meetings between assembly workers and design engineers. Also, ensuring all design subcontractors use the same standards and software prevents costly conversions and rework. It has been found that effective enterprise process alignment is dependent on one or more subfactors, which may comprise: program sponsorship of increased process capabilities; supply chain process alignment; and management of increased process capability.

Referring to FIG. 15, the maturity of a program's enterprise process alignment may be determined by comparing the program of interest against certain benchmarks. For example, as previously described, a six point subfactor scoring continuum may be tailored to evaluate the subfactors attributed to the enterprise process alignment critical performance area.

Subfactor 11.1: Program Sponsorship of Increased Process Capabilities. No program funding provided to increase process capabilities. Processes use unauthorized program funds to execute improvements that are not in the program's interest. Process improvements are executed to advance process goals without official program sponsorship. Program provides opportunities and budgets to improve existing processes. Program funded program process improvements are aligned with enterprise strategic goals. Customer incentives and funds increased process capabilities in line with the end user strategic goals.

Subfactor 11.2: Supply Chain Process Alignment. Partners have competing process goals which hamper successful program completion. Partner process goals are not aligned nor competing. Enterprise has stable processes but each partner is separately aligned. Enterprise has relatively good alignment but there are integration challenges. Enterprise has seamless process integration throughout the program. Enterprise has seamless process integration throughout the projected business base.

Subfactor 11.3: Management of increased process capability. Program is negatively impacted by uncoordinated and/or unmanaged process improvement. Program has no influence on the timing or extent of process changes leading to disruptions and schedule delays. Program internal process changes are coordinated, however, there are program disruptions and/or negative cost impacts when incorporating externally mandated process changes. Partner internal program process changes are managed to minimize internal disruption without regard to overall enterprise impact addition limited program benefits. Program internal process changes are incorporated seamlessly, but there are challenges across the enterprise. Process changes across the enterprise are incorporated seamlessly; the significantly improve performance across other programs.

As shown in FIG. 15, the subfactors contributing to the enterprise process alignment critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the enterprise process alignment critical performance area subfactors with the following ranges may be useful for evaluating programs in the aviation and defense industries: program sponsorship of increased process capabilities 11.1, weight of 10-30%; supply chain process alignment 11.2, weight of 20-40%; and management of increased process capability 11.3, weight of 40-60%. The combined aggregate weight of subfactors 11.1 through 11.3 should total 100%.

The enterprise process alignment critical performance area score may be calculated by multiplying the subfactor weight times the subfactor score for each subfactor and adding the results as indicated in the following formula:

Alignment Score=(W_{11.1}*S_{11.1})+(W_{11.2}*S_{11.2})+(W_{11.3}*S_{11.3})

In the implementation of FIG. 15, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Suppliers & Supply Chain Management

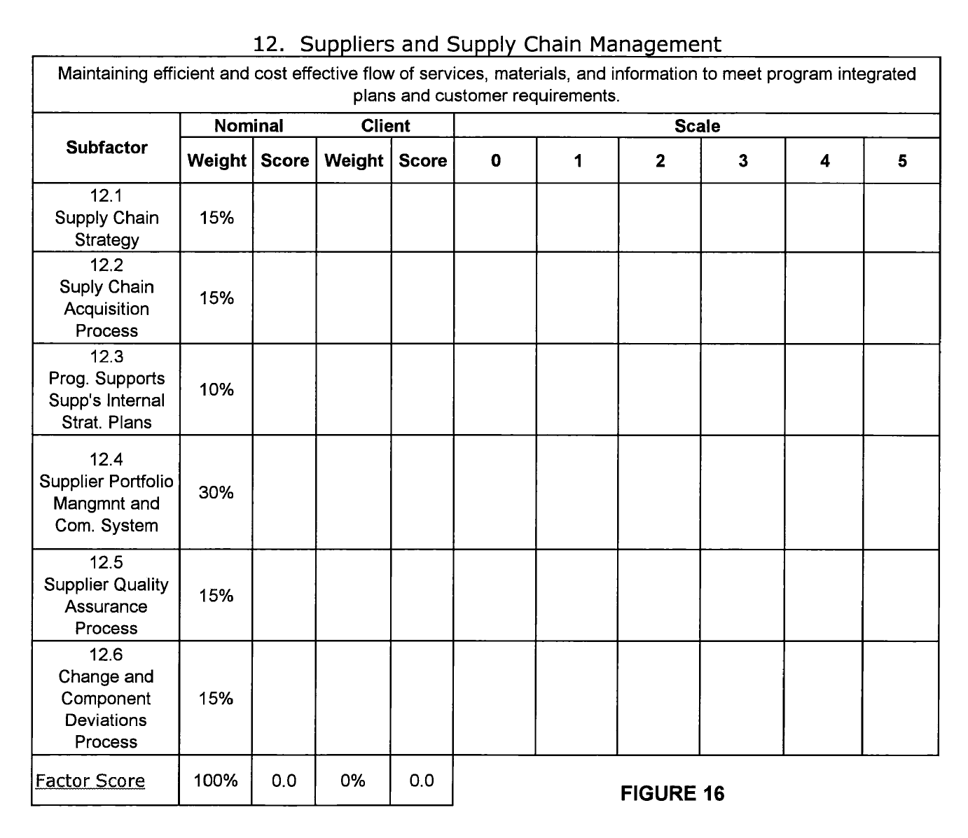

FIG. 16 provides an example of an illustrative score card relating to the supplier and supply chain management critical performance area. This category reflects the extent to which the program manager and team maintain efficient and cost effective flow of services, materials, and information to meet the program integrated plans and customer requirements. For example, the program objectives can be better served by encouraging system suppliers and system integrators to enter into a long term memorandum of understanding with respect to developing next generation systems, such as next generation unmanned aerial vehicles (UAV's). A program may also be served by having a large, established contractor enter into a Department of Defense “Mentor-Protege” agreement to help a small, socio-economically disadvantaged supplier develop the necessary quality assurance programs to effectively compete for new work. Another example includes having a supplier's financial and performance measurement systems integrated with the prime contractor's Earned Value Management System to provide real-time cost, schedule and technical accomplishment status.

It has been found that effective supplier and supply chain management is dependent on one or more subfactors, which may comprise: supply chain strategy; supply chain acquisition process; program supports supplier internal strategic plans; supplier portfolio management and communication system; supplier quality assurance process; and change and component deviations process.

Referring to FIG. 16, the maturity of a program's supplier and supply chain management may be determined by comparing the program of interest against certain benchmarks. For example, as previously described, a six point subfactor scoring continuum may be tailored to evaluate the subfactors attributed to the proposal preparation critical performance area.

Subfactor 12.1: Supply Chain Strategy. No program supply chain or alliance strategy, or no awareness of higher-level strategy. Program has supply chain strategy but is not aligned with other Programs. Higher-level supply chain strategy incorporated into Program. Program seeks supply chain leverage. Program supply chain strategy includes strategic value elements (SHV, EVM, etc.); Program is not accountable for results. Program and program manager accountability for contributions to strategic value elements. Both corporate and program manager actively engaged in refining and stretching strategic supply chain leverage.

Subfactor 12.2: Supply Chain Acquisition Process. Minimum procurement capabilities, non-centralized, no policies, procedures, standards. Acquisition process has standards, policies & procedures but Program is not in compliance. Program in basic compliance with acquisition system but system does not include strategic value elements. Program in compliance with formal acquisition system that includes strategic value elements. Acquisition systems integrated with other PM systems; acquisition process includes multiple program bundling, web-enabled/electronic acquisition systems in use. Supply chain integrated forward & backward where appropriate; strategy evolving based on changing circumstances; emerging technologies/practices in use.

Subfactor 12.3: Program Supports Suppliers Internal Strategic Plans. Program has no supplier synergy in CPI or other current program/program development activities. Program has some supplier synergy with existing product lines or product/process development activities. Program basically aligns with either existing supplier product lines or product/process development activities. In addition, Program drives supplier development activities. Program fits into supplier Long Term Strategic plan and is key to future Corporate direction. Alliance strategy exploits supplier/SBU synergies. Program fits into part of supplier's enterprise Long Term Strategic plan and is key to supplier's future Enterprise direction.

Subfactor 12.4: Supplier Portfolio Management and Communication System. No supplier management system. Informal ad hoc supplier management system, informal supplier communications, unidentified goals to optimize supplier relationships. Supplier management system exists, formal goals in place to optimize supplier relationship, but not used consistently. Supplier management system in use regularly, regular communications, and activities focused on supplier leverage. Supplier portfolio strategy, implemented by Program Team with accountability for improved supplier leverage. Program aligned with and participating in enterprise portfolio strategy and communication protocols; emerging technologies, KPIs.

Subfactor 12.5: Supplier Quality Assurance Process. No supplier quality programs exist. Supplier Quality verified by spot receiving inspection coupled with on site quality audits. Supplier quality assured by process step certifications and spot receiving inspections. Supplier fully compliant with appropriate ISO quality standards, with active self auditing. Supplier quality designed into the program deliverables through joint activities. Supplier payments are tied to systems acceptance by OEM customers. Part rejects discarded without payment.

Subfactor 12.6: Change and Components Deviations Process. Internal Program change and component deviation process decoupled from supplier change process and any alignment is not timely. Internal Program Change and component deviation process informally connected to supplier change process and alignment improves still don't lead to acceptable synchronization. Internal Program change and component deviation process formally connected to supplier change process but people based and alignment acceptable but not rapid. Wider use of IT technologies enables some notice process automation makes alignment rapid but still people intensive. On line collaboration tools enable coupling but databases are not fall coupled forcing formal processes to provide notices and negotiate alignment reducing labor to achieve timely alignment. Web based standardized supplier interactions with OEM coupled with formal on-line links between technical, contract and supplier change and component deviations assure timely distribution and alignment at low cost.

As shown in FIG. 16, the subfactors contributing to the supplier and supply chain management critical performance area score for a program of interest may each be evaluated against established bench marks. The subfactor scores may then be weighted or assigned a weighting factor according to program or organization specific criteria, or alternatively may be weighted against established or nominal weighted scores. The weighting factor associated with each subfactor may be between 0 and 100%, though it has been found that nominal weighting factors for the supplier and supply chain management critical performance area subfactors with the following ranges may be useful for evaluating programs in the aviation and defense industries: supply chain strategy 12.1, weight of 5-25%; supply chain acquisition process 12.2, weight of 5-25%; program supports supplier internal strategic plans 12.3, weight of 0-20%; supplier portfolio management and communication system 12.4, weight of 20-40%; supplier quality assurance process 12.5, weight of 5-25%; and change and component deviations process 12.6, weight of 5-25%. The combined aggregate weight of subfactors 12.1 through 12.6 should total 100%.

The supplier and supply chain management critical performance area score may be calculated by multiplying the subfactor weight times the subfactor score for each subfactor and adding the results as indicated in the following formula:

Supplier Man. Score=(W_{12.1}*S_{12.1})+(W_{12.2}*S_{12.2})+(W_{12.3}*S_{12.3})+(W_{12.4}*S_{12.4})+(W_{12.5}*S_{12.5})+(W_{12.6}*S_{12.6})

In the implementation of FIG. 16, the nominal score assigned to each subfactor may be compared with the client score which is obtained using subfactor weights assigned by the user or client. Additionally, in an implementation, nominal scores, client scores, and client assigned weights may be recorded in an internal or external database for future reference. In one implementation, the nominal weighting factor may be derived from a statistical analysis of client assigned weighting factors across similar industry segments or categories.

Other implementations and features are within the scope of the following claims:

What is claimed:

1. A computer implemented evaluation method comprising:
defining one or more critical areas within an industry segment with one or more performance subfactors;
scoring the one or more subfactors;
weighting the one or more subfactors relative to all subfactors within the one or more critical areas; and
scoring the one or more critical areas based on a weighted subfactor score.

2. The evaluation method of claim 1 wherein the one or more critical areas are unique to an industry segment and generic to programs within the industry segment.

3. The evaluation method of claim 1 wherein the one or more critical areas is chosen from the group comprising: executive championship; program manager and program team competence; user/customer involvement and expectations; learning culture; program baseline planning and resourcing; change management; performance measurement and program execution; risk management process; alignment of goals and objectives; proposal preparation; enterprise process alignment; suppliers and supply chain management.

4. The evaluation of claim 1 wherein the step of scoring the one or more subfactors includes a subfactor scoring scale.

5. The evaluation method of claim 4 wherein the step of scoring the critical area includes a critical area scoring scale that is the same as the subfactor scoring scale.

6. The evaluation method of claim 1 wherein the step of weighting the one of more subfactors includes a weighting factor comprising a pre-assigned weighting factor, a user-assigned weighting factor, or a historically assigned weighting factor.

7. The evaluation method of claim 1 wherein the step of weighting the one of more subfactors includes a weighting factor comprising a combination of a pre-assigned weighting factor, a user-assigned weighting factor, and a historically assigned weighting factor.

8. The evaluation method of claim 1 wherein the step of weighting the one of more subfactors is accomplished after the scoring the one or more subfactors.

9. The evaluation method of claim 1 further comprising:
scoring the one or more subfactors relative to a subfactor scoring scale; and
reporting the one or more scored critical areas comparatively on at least one axis comprising the subfactor scoring scale.

10. The evaluation method of claim 10 wherein the step of reporting the one or more scored critical areas produces a spider chart.

11. The evaluation method of claim 1 further comprising:
recording the subfactor score, weighting factor, and weighted subfactor scores.

12. A computer readable medium having stored thereon a computer program that when executed causes a computer to perform the steps of:
defining one or more critical areas within an industry segment with one or more performance subfactors;
scoring the one or more subfactors;
weighting the one or more subfactors relative to all subfactors within the one or more critical areas; and
scoring the one or more critical areas based on a weighted subfactor score.

13. The computer readable medium of claim 12 wherein the one or more critical areas are unique to an industry segment and generic to programs within the industry segment.

14. The computer readable medium of claim 12 wherein the one or more critical areas is chosen from the group comprising: executive championship; program manager and program team competence; user/customer involvement and expectations; learning culture; program baseline planning and resourcing; change management; performance measurement and program execution; risk management process; alignment of goals and objectives; proposal preparation; enterprise process alignment; suppliers and supply chain management.

15. The computer readable medium of claim 12 wherein scoring the one or more subfactors includes a subfactor scoring scale.

16. The computer readable medium of claim 15 wherein scoring the critical area includes a critical area scoring scale that is the same as the subfactor scoring scale.

17. The computer readable medium of claim 12 wherein weighting the one of more subfactors includes a weighting factor comprising a pre-assigned weighting factor, a user-assigned weighting factor, or a historically assigned weighting factor.

18. The computer readable medium of claim 12 wherein the weighting the one of more subfactors includes a weighting factor comprising a combination of a pre-assigned weighting factor, a user-assigned weighting factor, and a historically assigned weighting factor.

19. The computer readable medium of claim 12 wherein weighting the one of more subfactors is accomplished after the scoring the one or more subfactors.

20. The computer readable medium of claim 12 further comprising:
scoring the one or more subfactors relative to a subfactor scoring scale; and
reporting the one or more scored critical areas comparatively on at least one axis comprising the subfactor scoring scale.

21. The computer readable medium of claim 20 wherein reporting the one or more scored critical areas produces a spider chart.

22. The computer readable medium of claim 12 further comprising:
recording the subfactor score, weighting factor, and weighted subfactor scores.
